(19) United States
(12) Patent Application Publication
(10) Pub. No.: US 2022/0257459 A1
(43) Pub. Date: Aug. 18, 2022

(54) SEXUAL STIMULATION DEVICE

(71) Applicant: Daniel James Dickinson, Lincolnshire, IL (US)

(72) Inventor: Daniel James Dickinson, Lincolnshire, IL (US)

(21) Appl. No.: 17/525,056

(22) Filed: Nov. 12, 2021

Related U.S. Application Data
(63) Continuation-in-part of application No. 17/175,778, filed on Feb. 15, 2021.
Application No. 17/175,778 is a continuation-in-part of application No. 17/351,429, filed on Jun. 18, 2021.

(51) Int. Cl. A61H 19/00; A61H 23/02

(52) U.S. Cl. CPC A61H 19/44; A61H 19/34; A61H 23/0263; A61H 2201/5007; A61H 2201/1215; A61H 2201/149; A61H 2201/0157

(57) ABSTRACT

Disclosed embodiments provide an improved stimulation device for sexual gratification. An enclosure includes a moveable shaft in a phallic shape, and a vibration surface located near the base of the shaft. The arrangement allows the shaft to be inserted in the vagina of a user while the vibration surface is in contact with the clitoral region of the user. In use, the shaft thrusts back and forth in the vagina. In some embodiments, the enclosure comprises two concave sides and a convex opposing surface. The concave side surfaces are well suited to accommodate the legs of a user. The convex opposing surface enables a rocker mode of operation in which the user places the device on a floor surface such that the convex opposing surface is on the floor, and then straddles the device, enabling a rocking motion during stimulation, which can create an enhanced user experience.

### RELATED APPLICATIONS

The present patent document is a continuation in part of U.S. patent application Ser. No. 17/175,778, filed Feb. 15, 2021, titled “SEXUAL STIMULATION DEVICE,” and a continuation-in-part of U.S. patent application Ser. No. 17/351,429, filed Jun. 18, 2021, also titled “SEXUAL STIMULATION DEVICE,” the entire contents of which are incorporated herein by reference.

### FIELD

Disclosed embodiments relate generally to sexual stimulation devices.

### BACKGROUND

There are numerous devices available for use by people for sexual stimulation. They include products that are manually operated, and achieve stimulation by shape and/or texture, as well as devices that are provided with internal motors that achieve stimulation by shape, texture and vibration. These latter devices, commonly referred to as vibrators, can be phallus shaped, and may include a handle for manipulation in and around the genital or anal region. In general, there are at least three distinct effective genital stimulation areas on a vulva, namely the clitoris and surrounding skin, the inner surface of the vagina and the Grafenberg-spot (i.e., G-spot), a nerve reflex area inside the vagina, along the anterior surface. Sexual stimulation devices can be used to promote a healthy sex life and increase sexual pleasure. It is therefore desirable to have improvements in sexual stimulation devices.

### SUMMARY

Disclosed embodiments provide an improved stimulation device for sexual gratification. An enclosure includes a moveable shaft (internal massage surface) in a phallic shape, and an external massage surface located near the base of the shaft. The arrangement allows the shaft to be inserted in the vagina or anus of a user. During use, the vibration surface is aligned for stimulation of the clitoris, or in some embodiments, the scrotum, perineum, or penis. In use, the shaft thrusts back and forth in the vagina (or anus). In some embodiments, the enclosure comprises two concave sides and a convex opposing surface. The concave side surfaces are well suited to accommodate the legs of a user. The convex opposing surface enables a rocker mode of operation in which the user places the device on a floor surface such that the convex opposing surface is on the floor, and then straddles the device, enabling a rocking motion during stimulation, which can create an enhanced user experience.

In some embodiments, there is provided a sexual stimulation device, comprising: an enclosure, wherein the enclosure comprises: a shaft-side surface, a first concave side surface, and a second concave side surface; a thrustable shaft extending from the shaft-side surface of the enclosure; and a driver mechanically coupled to the thrustable shaft, wherein the driver comprises: a first servo motor; and a second servo motor, wherein the second servo motor is mechanically coupled to the first servo motor.

In some embodiments, there is provided a sexual stimulation device, comprising: an enclosure, wherein the enclosure comprises: a shaft-side surface, a first concave side surface, and a second concave side surface; a thrustable shaft extending from the shaft-side surface of the enclosure; and a driver mechanically coupled to the thrustable shaft, wherein the thrust driver comprises: a first servo motor; a second servo motor, wherein the second servo motor is mechanically coupled to the first servo motor; and an internal mount bracket affixed to an interior surface of the enclosure, wherein the first servo motor and second servo motor are affixed to the internal mount bracket.

### BRIEF DESCRIPTION OF THE DRAWINGS

The accompanying drawings, which are incorporated in and constitute a part of this specification, illustrate several embodiments of the present teachings and together with the description, serve to explain the principles of the present teachings.

FIG. 1 shows a perspective view of an embodiment of the present invention.

FIG. 2 shows a perspective view of internal components of an embodiment of the present invention.

FIG. 3A is a side view of internal components in a lowered position.

FIG. 3B is a side view of internal components in an intermediate position.

FIG. 3C is a side view of internal components in a raised position.

FIG. 4A is a side view of a tip.

FIG. 4B is a top-down view of a tip.

FIG. 4C is a perspective view of a tip.

FIG. 5A is a perspective view of a side bracket.

FIG. 5B is a side view of a side bracket.

FIG. 6A is a perspective view of a pivot beam.

FIG. 6B is a side view of a pivot beam.

FIG. 7 is a perspective view of the pivot beam in an assembly.

FIG. 8 is an illustration indicating arcs of motion for an assembly.

FIG. 9 shows a rear-perspective view of an embodiment of the present invention.

FIG. 10 shows a side view of an embodiment of the present invention.

FIG. 11 shows a rear view of an embodiment of the present invention.

FIG. 12 is a block diagram indicating components in accordance with embodiments of the present invention.

FIG. 13 illustrates usage of a disclosed embodiment in a side position.

FIG. 14 illustrates usage of a disclosed embodiment in a rocker mode of operation.

FIG. 15 shows details of a vibration mechanism of disclosed embodiments.

FIG. 16A-16C show details of a vibration capsule of disclosed embodiments.

FIG. 17 is a perspective view of an additional embodiment of the present invention including a thrusting shaft.

FIG. 18 is a side view of the embodiment of FIG. 17 shown the shaft in an extended configuration.

FIG. 19 is a side view of the embodiment of FIG. 17 shown the shaft in a retracted configuration.

FIG. 20 is a front view of the embodiment of FIG. 17.

FIG. 21 is a rear view of the embodiment of FIG. 17.

FIG. 22 is a side cutaway view of the embodiment of FIG. 17 showing internal components.

FIG. 23 shows details of the thrusting driver of disclosed embodiments.

FIG. 24 is a sectional view showing additional details of the thrusting driver of disclosed embodiments.

FIG. 25 shows details of the sheath with integrated thruster slug.

FIG. 26 shows details of shaft installation in disclosed embodiments.

FIG. 27 is a sectional view showing additional details of the thrusting driver of disclosed embodiments.

FIG. 28A-28C show a motion sequence in sectional view for embodiments of the present invention.

FIG. 29A-29D show a thrusting mechanism in accordance with additional embodiments of the present invention.

FIG. 30 shows a bottom-up view of the embodiments.

FIG. 31 shows a close-up view of a user interface on remote device 1101.

FIG. 32A shows a side view of an internal mount bracket in accordance with additional embodiments of the present invention.

FIG. 32B shows a front view of the internal mount bracket of FIG. 32A.

FIG. 32C shows a top-down view of the internal mount bracket of FIG. 32A.

FIG. 33A is a front perspective view of an assembly using the internal mount bracket of FIG. 32A.

FIG. 33B is a top-down view of the assembly of FIG. 33A.

FIG. 33C is a rear perspective view of the assembly of FIG. 33A.

FIG. 33D is a side view of the assembly of FIG. 33A in an extended position.

FIG. 33E is an opposite-side view of the assembly of FIG. 33A in an extended position.

FIG. 33F is a side view of the assembly of FIG. 33A in a retracted position.

FIG. 33G is a side perspective view of an example exterior that houses the assembly of FIGS. 33A-33F.

FIG. 34 shows a cross-section of the shaft.

FIG. 35A shows a rear view of the shaft.

FIG. 35B shows a rear view of the shaft installed on a shaft track.

FIG. 36 shows details of the shock mounts used in accordance with embodiments of the present invention.

FIG. 37 shows an interior view of a front enclosure in accordance with embodiments of the present invention.

FIG. 38 is a cross section showing the configuration of the shock mounts for the front enclosure.

FIG. 39 shows a side view of an internal mount bracket in accordance with additional embodiments of the present invention.

The drawings are not necessarily to scale. The drawings are merely representations, not necessarily intended to portray specific parameters of the invention. The drawings are intended to depict only example embodiments of the invention, and therefore should not be considered as limiting in scope. In the drawings, like numbering may represent like elements. Furthermore, certain elements in some of the figures may be omitted, or illustrated not-to-scale, for illustrative clarity.

### DETAILED DESCRIPTION

Disclosed embodiments provide an improved stimulation device for sexual gratification. An enclosure includes a shaft in a phallic shape having a moveable tip, and an external massage surface located near the base of the shaft. The arrangement allows the shaft to be inserted in the vagina or anus of a user. During use, the external massage surface is aligned for stimulation of the clitoris, or in some embodiments, the scrotum, perineum, or penis. In embodiments, the enclosure comprises two concave sides and a convex opposing surface (or “convex surface” herein). In some embodiments, the external massage surface vibrates as described herein. Note that the vibration can be substituted with pulsation, gyration, or other massage pattern within the scope of the invention. The concave side surfaces are well suited to accommodate the legs of a user. The convex opposing surface enables a rocker mode of operation in which the user places the device on a floor surface such that the convex opposing surface is on the floor, and then straddles the device, enabling a rocking motion during stimulation, which can create an enhanced user experience. In some embodiments, the sides may not be concave. In some embodiments, the sides may be straight, convex, or other suitable shape.

Reference throughout this specification to “one embodiment,” “an embodiment,” “some embodiments”, or similar language means that a particular feature, structure, or characteristic described in connection with the embodiment is included in at least one embodiment of the present invention. Thus, appearances of the phrases “in one embodiment,” “in an embodiment,” “in some embodiments”, and similar language throughout this specification may, but do not necessarily, all refer to the same embodiment.

Moreover, the described features, structures, or characteristics of the invention may be combined (“mixed and matched”) in any suitable manner in one or more embodiments. It will be apparent to those skilled in the art that various modifications and variations can be made to the present invention without departing from the spirit and scope and purpose of the invention. Thus, it is intended that the present invention cover the modifications and variations of this invention provided they come within the scope of the appended claims and their equivalents. Reference will now be made in detail to the preferred embodiments of the invention.

The terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. The term “set” is intended to mean a quantity of at least one. It will be further understood that the terms “comprises” and/or “comprising”, or “includes” and/or “including”, or “has” and/or “having”, when used in this specification, specify the presence of stated features, regions, integers, steps, operations, elements, and/or components, but do not preclude the presence or addition of one or more other features, regions, and/or elements. For the purposes of disclosure, the word, “substantially” is defined as “for the most part”. It means “to a great extent,” but having some room for some minor variation.

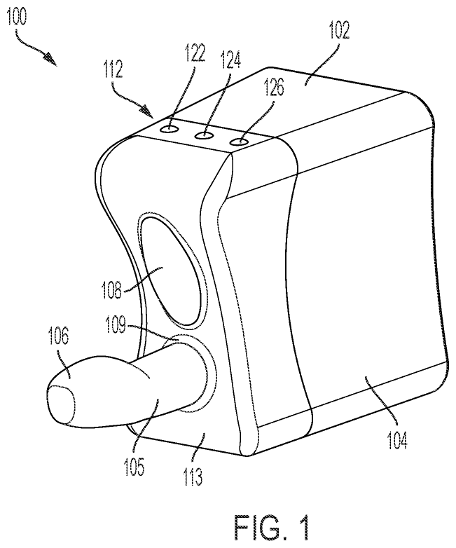

FIG. 1 shows a perspective view of an embodiment of the present invention. Device 100 includes an enclosure 102. The enclosure 102 has a side surface 104. In embodiments, side surface 104 has a concave shape that is well-suited to conform to the convex shape of the leg of a user. Device 100 further comprises a shaft 105 (an internal massage surface, i.e., for internal stimulation of the vagina or anus), and in some embodiments, an external massage surface 108 for external parts of the body, such as the clitoris, perineum, penis, or scrotum. The shaft 105 protrudes from a shaft-side surface 113 of enclosure 102. The shaft 105 has tip region 106 on a distal end of the shaft 105. In embodiments, the vibration surface 108 is disposed on the enclosure 102 between 3 centimeters to 6 centimeters above the shaft attachment point 109. In this way, when the shaft 105 is inserted into the vagina of a user, the external massage surface 108 is disposed on the clitoris region of the user. In embodiments, the tip region 106 has a larger diameter than the diameter of the shaft 105. In some embodiments, the external massage surface 108 is a vibration surface. In some embodiments, instead of vibration, there is pulsation, gyration or other suitable massage pattern or mechanism. In embodiments, the shaft 105 includes, or is fit within, a flexible exterior surface (sheath). In some embodiments, the sheath may be elastic.

The enclosure may further include a user interface 112. In embodiments the user interface may include one or more buttons, indicated as 122, 124, and 126. In embodiments, button 122 is an on/off button for the device 100. In embodiments, button 124 is a start/stop button for the external massage surface 108. In embodiments, button 126 is a start/stop button for the tip motion function that controls movement of tip region 106 with respect to shaft 105. The tip motion can be used to stimulate the G-spot of a user during operation of the device 100.

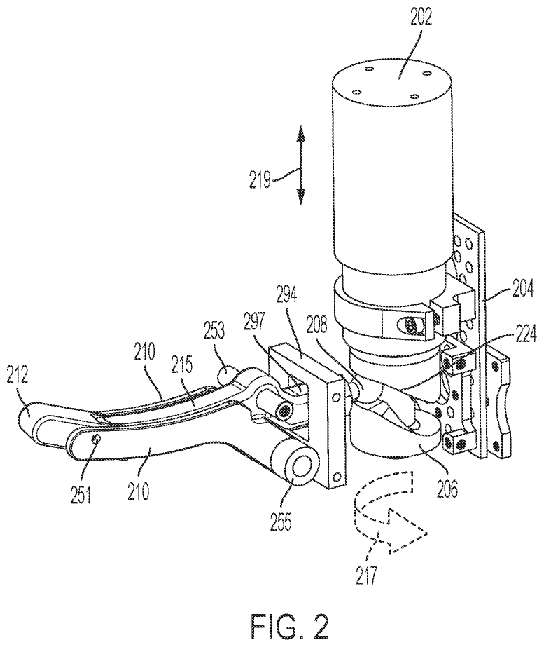

FIG. 2 shows a perspective view of internal components of an embodiment of the present invention. Internal components shown in FIG. 2 are disposed within an interior of the enclosure 102, and serve to operate the tip deflection motion function of disclosed embodiments. Shaft motor 202 is affixed to chassis portion 204. The shaft motor 202 rotates in the direction indicated by arrow 217. In some embodiments, the motor may rotate in the opposite direction, and/or alternate between the two directions. In some embodiments, the shaft motor 202 may be a 12 Volt DC planetary gearmotor. The shaft motor 202 is coupled to a barrel cam 206. Barrel cam 206 comprises groove 224 that varies in position along the circumference of the barrel cam 206.

Pivot beam 215 includes a pin 208 that is mechanically engaged with the groove 224 of the barrel cam 206. As the barrel cam 206 rotates, the pin 208 is moved in a vertical direction as indicated by arrow 219. This causes pivot beam 215 to move about bushing 253 which serves as a pivot point. The pivot beam 215 traverses an opening 297 within chassis portion 294. Pivot beam 215 is also rotatably attached to side brackets 210. Side brackets 210 rotate about bushings 255 which serve as pivot points. As the pivot beam 215 moves, the side brackets 210 cause the deflection of tip 212, which is rotatably attached to the side brackets at pivot point 251. The tip is also rotatably attached to the pivot beam 215.

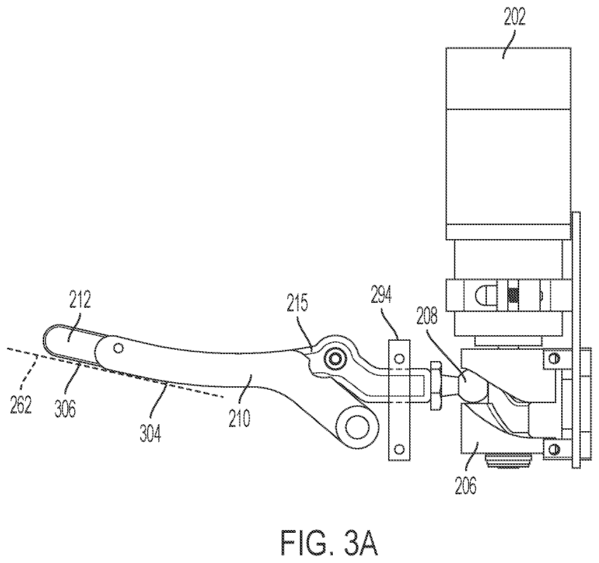

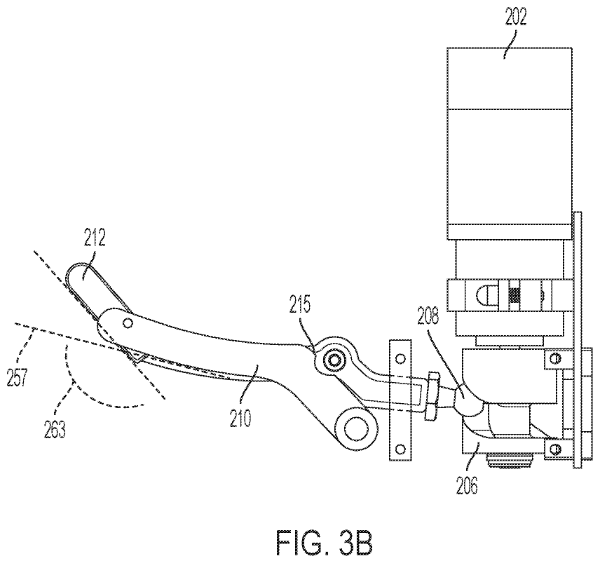

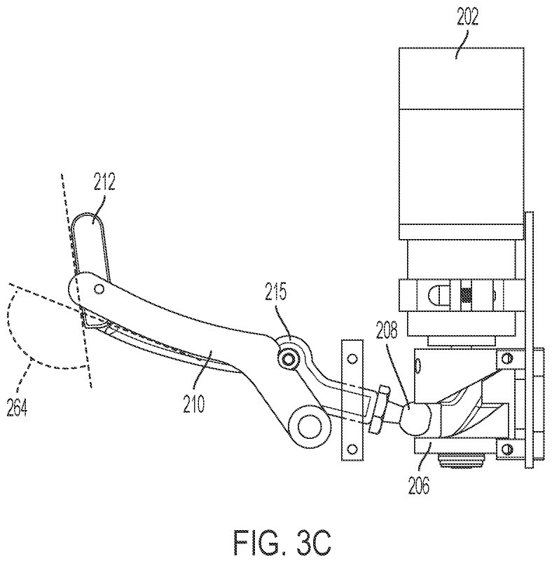

FIGS. 3A-3C show operation of the moveable tip 212. FIG. 3A is a side view of internal components in a lowered position. Tangent line 262 is shown in contact with the tip 212 and an adjacent region of the lower edge 304 of side bracket 210. In this view, the lower edge 306 of tip 212 is parallel to tangent line 262. FIG. 3B is a side view of internal components in an intermediate position. As shown in FIG. 3B. the barrel cam 206 as rotated from the position shown in FIG. 3A, such that pin 208 shown in FIG. 3B is lower than shown in FIG. 3A. This causes pivot beam 215 to elevate, which causes side brackets 210 to elevate, causing tip 212 to deflect at angle 263 with respect to the side brackets 210. Line 257 represents a longitudinal axis of the pivot beam. As can be seen in FIG. 3B, the tip 212 can deflect with respect to a longitudinal axis of the pivot beam at an angle 263.

FIG. 3C is a side view of internal components in a fully raised position. In this view, the barrel cam 206 is rotated from the position shown in FIG. 3A, such that pin 208 shown in FIG. 3C is at its lowest point, causing tip 212 to deflect at an angle 264, where angle 264 is an angle of maximum deflection. In embodiments, angle 264 ranges from 95 degrees to 125 degrees.

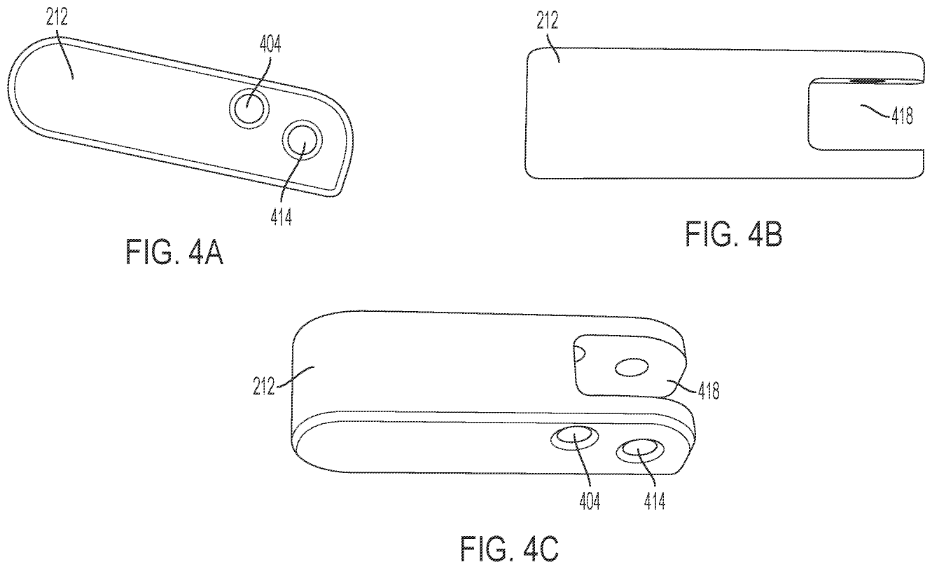

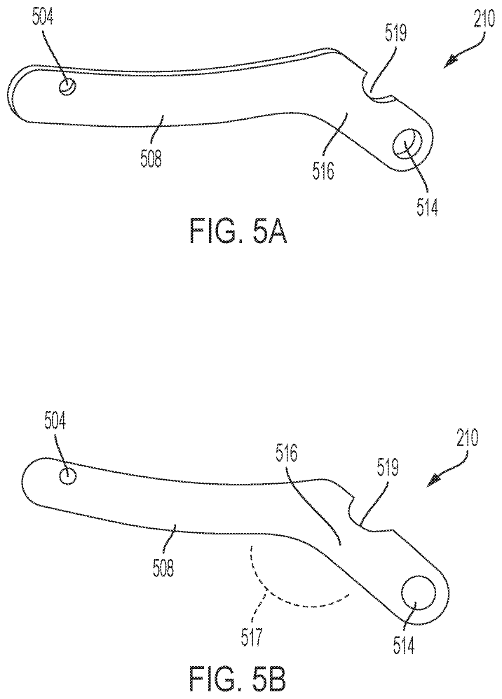

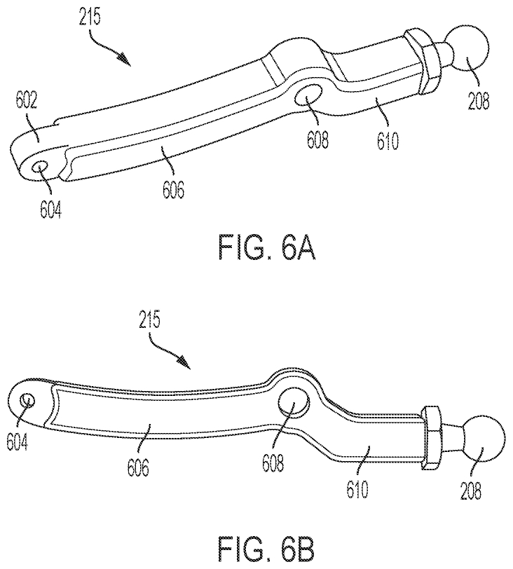

FIG. 4A is a side view of a tip 212. FIG. 4B is a top-down view of tip 212. FIG. 4C is a perspective view of tip 212. Tip 212 comprises a first opening 404 and a second opening 414. First opening 404 is used for rotatably attaching the tip 212 to the pivot beam 215. Second opening 414 is used for rotatably attaching the tip 212 to the side brackets 210. Tip 212 comprises notch 418 for engaging with the pivot beam 215.

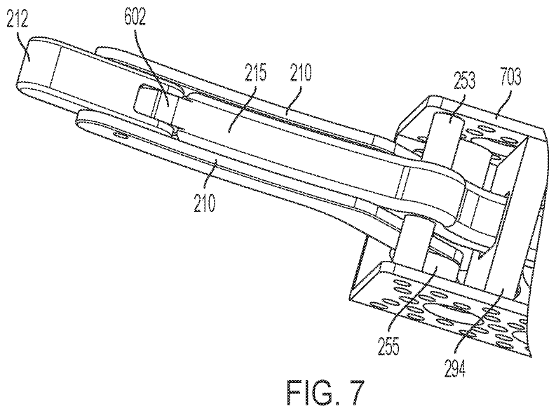

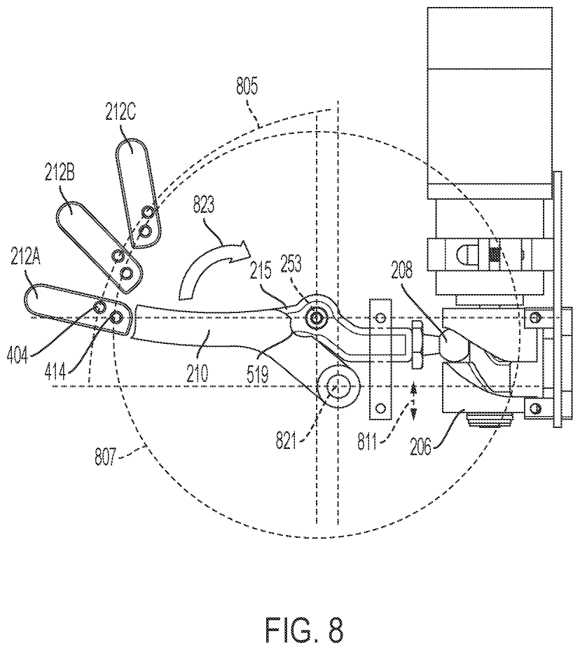

FIG. 5A is a perspective view of a side bracket 210. FIG. 5B is a side view of a side bracket 210. Side bracket 210 comprises first portion 516 and second portion 508. In embodiments, the first portion 516 and second portion 508 are joined at an angle 517. In embodiments, angle 517 ranges from 100 degrees to 160 degrees. A first opening 514 is used to rotatably attach the side bracket 210 to the chassis. A second opening 504 is used to rotatably attach the side bracket 210 to the tip 212. First portion 516 comprises concave cutout 519 formed therein. In embodiments, concave cutout 519 periodically contacts a bushing during operation as the side bracket 210 moves.

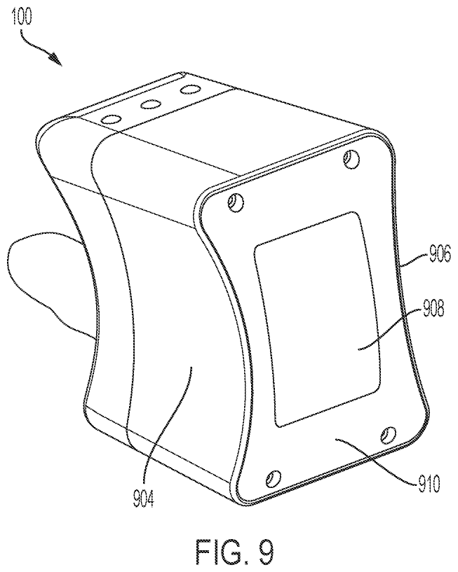

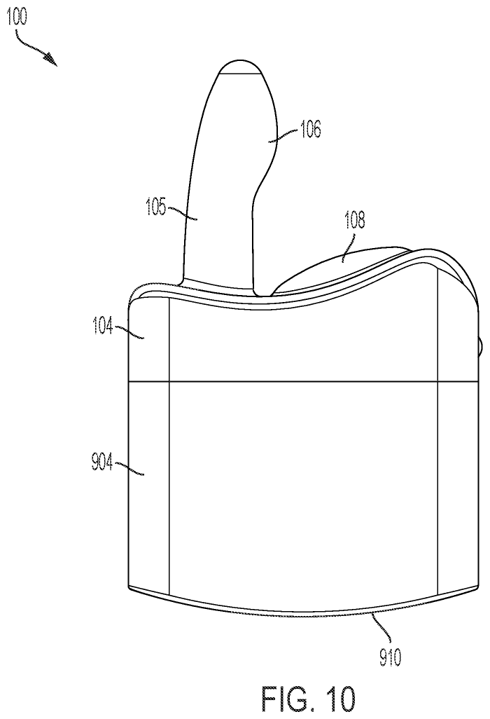

FIG. 6A is a perspective view of pivot beam 215. FIG. 6B is a side view of a pivot beam 215. Pivot beam 215 includes a pin 208 affixed to a first section 610. The first section 610 is joined to a second section 606 with an opening 608 formed therein between the first section 610 and second section 606. The opening 608 is used to rotatably attach the pivot beam 215 to the chassis of the device. An additional opening 604 is formed at distal end 602 of the pivot beam 215. The opening 604 is used to rotatably attach the pivot beam 215 to the tip 212. The distal end 602 is narrower than the second section 606 so that the distal end can fit within notch 418 of the tip 212.

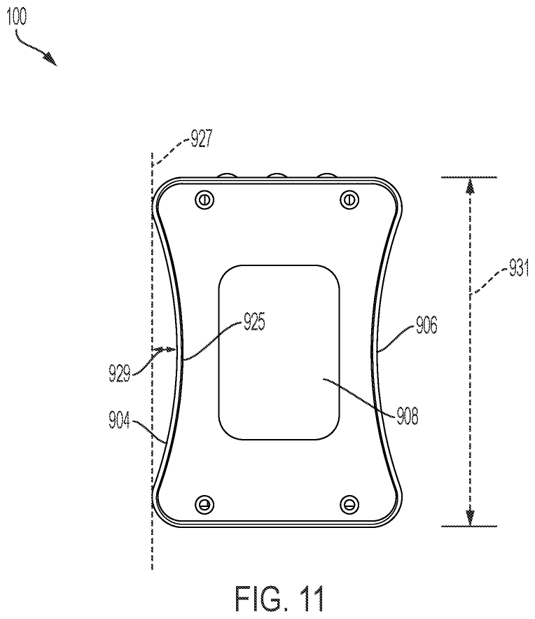

FIG. 7 is a perspective view of the pivot beam in an assembly. As can be seen in FIG. 7, a side bracket 210 is installed on two sides of the pivot beam 215. The distal end 602 of the pivot beam 215 engages with the tip 212. The pivot beam is rotatably affixed to the chassis section 703 via bushing 253, which traverses opening 608 of the pivot beam. In this view, it can be seen that the assembly includes two side brackets 210. The side brackets 210 are rotatably affixed to the chassis section 703 via bushings 255.

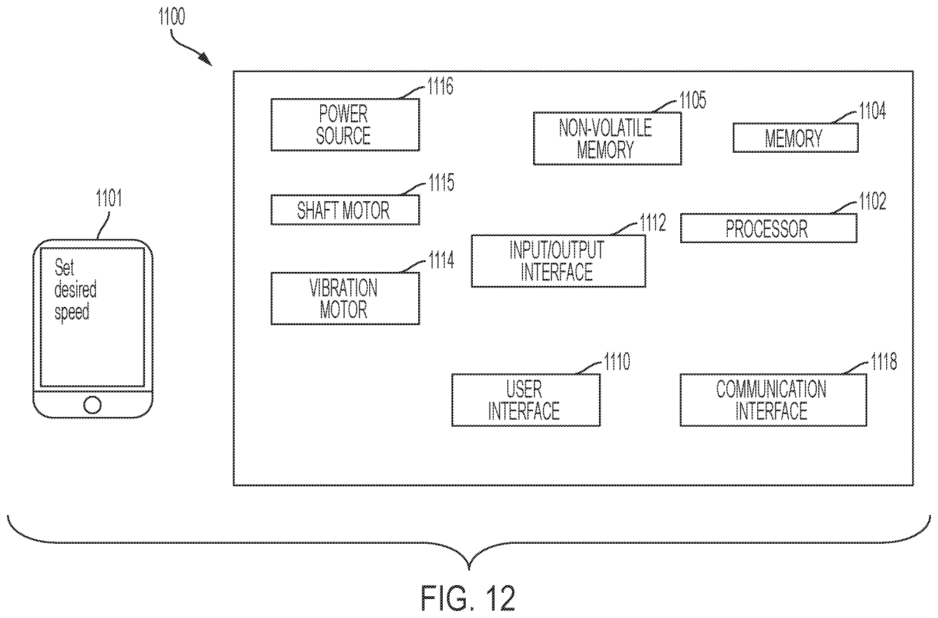

FIG. 8 is an illustration indicating arcs of motion for an assembly. As shown in FIG. 8, first arc 807 is off-center with respect to arc 805. Arc 807 includes a travel path for pivot beam 215. Arc 805 includes a travel path for side bracket 210. During operation, the barrel cam 206 rotates, causing pin 208 to move up and down in the direction indicated by arrow 811. Pivot beam 215 rotates about bushing 253, also causing side bracket 210 to rotate about point 821. As side bracket rotates, the two openings 404 and 414 of the tip cause the orientation of the tip to change as the pivot beam 215 rotates. As can be seen, arc 805 and arc 807 get closer together as the pivot beam 215 rotates in the direction of arrow 823. This forces the tip to change orientation as indicated by the sequence of tip motion indicated by 212A, 212B, and 212C. The motion of this tip can enable G-spot stimulation of a user during use. The moveable tip is rotatably attached to both the pivot beam 215, and the two side brackets 210, enabling the operation shown in FIGS. 3A-3C and also in FIG. 8. The tip, side brackets and pivot beam are disposed within a soft flexible sheath as an exterior surface (as shown in FIG. 1), to provide comfort and stimulation for a user. In embodiments, the sheath shown in FIG. 1 may be removable to allow for its cleaning. In some embodiments, the sheath is made of silicone, plastic, or another suitable material.

In embodiments, the pivot beam has a first point of rotation shown as 253, the first side bracket and second side bracket have a second point of rotation shown as 821, and the first point of rotation is different than the second point of rotation.

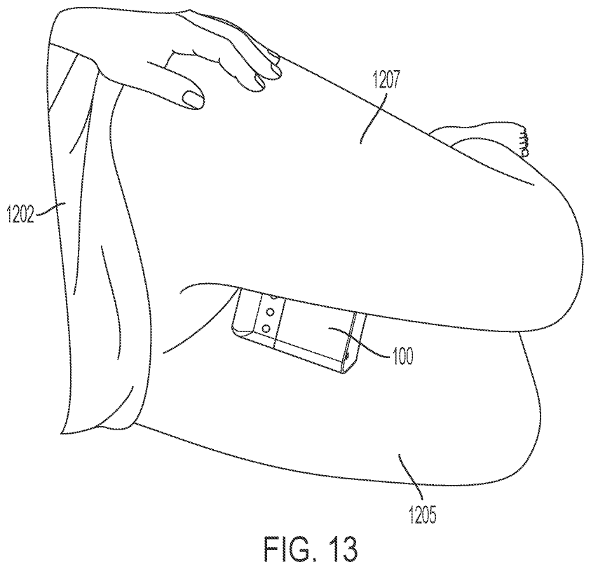

FIG. 9 shows a rear-perspective view of an embodiment of the present invention. As can be seen in FIG. 9, device 100 comprises a concave side 904 that is adapted to contact the leg of a user during use. A similar concave profile exists on opposite side 906. Concave surfaces are sized to fit a side of a human leg comfortably thereagainst. The opposing surface 910 is disposed opposite the shaft-side surface 113 and may be convex, and, in some embodiments, may also include a battery compartment 908 that contains a removeable battery. In this way, a battery for the device can be removed and replaced and/or charged, while the device 100 can be discretely stored out of sight. Thus, embodiments can include a removable rechargeable battery.

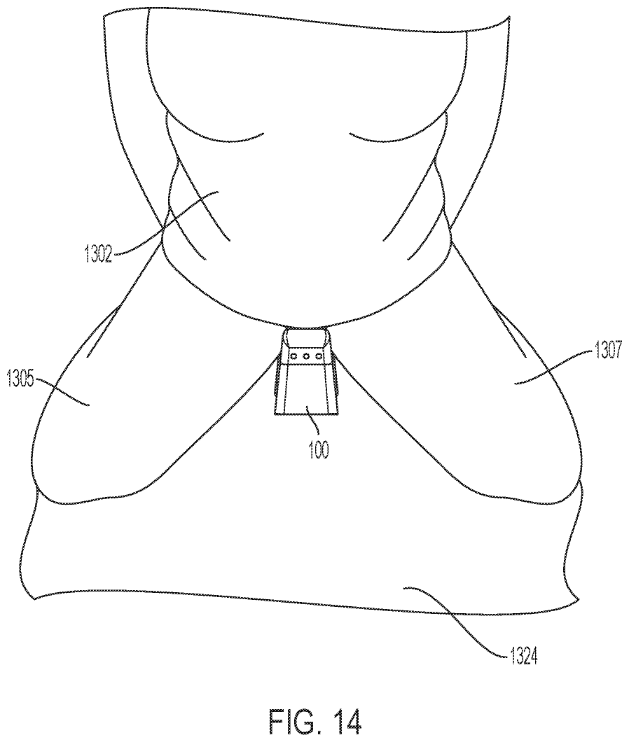

FIG. 10 shows a side view of an embodiment of the present invention. As can be seen in FIG. 10, in some embodiments, the device 100 has convex opposing surface 910. The convex opposing surface enables a “rocker” mode of operation. In the rocker mode of operation, the user places the device 100 on a floor surface, and then straddles the device to receive stimulation. The convex opposing surface 910 allows the user to rock back and forth while the tip of the shaft 105 moves as illustrated in FIG. 8 to provide G-spot stimulation. Additionally, or alternatively, the external massage surface 108 can be activated to provide clitoral stimulation.

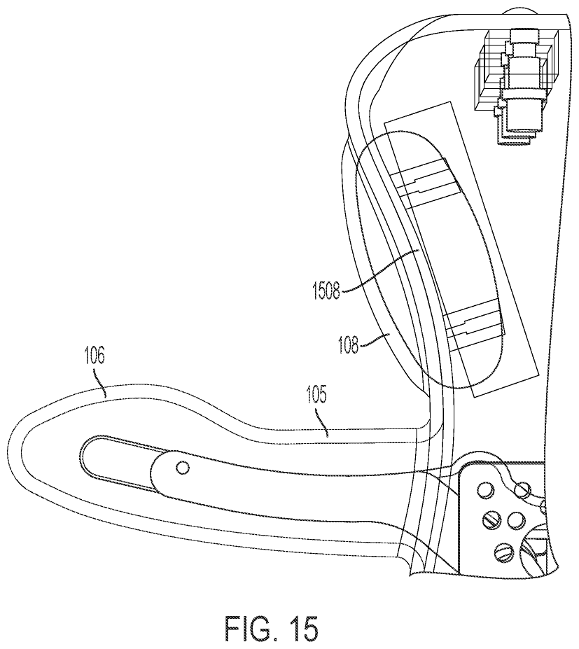

FIG. 11 shows a rear view of an embodiment of the present invention. As can be seen in FIG. 11, the sides 904 and 906 have a concave shape that is well-suited to engage with legs of a user during use. The battery compartment 908 contains a removable battery that can be replaced or recharged outside of the device 100. In some embodiments, the battery is rechargeable while inside the device, and removal is not generally necessary.

As can be seen in FIG. 11, the device 100 has a height 931. In embodiments, the height 931 ranges from 15 centimeters to 25 centimeters. The concavity of the sides 904 and 906 is such that there is a distance 929 between the inflection point 925 and the outer extent 927 of the side 904. In embodiments, the distance 929 ranges from two centimeters to five centimeters. These dimensions provide a gradual curve that can comfortably accommodate the leg sizes of most users.

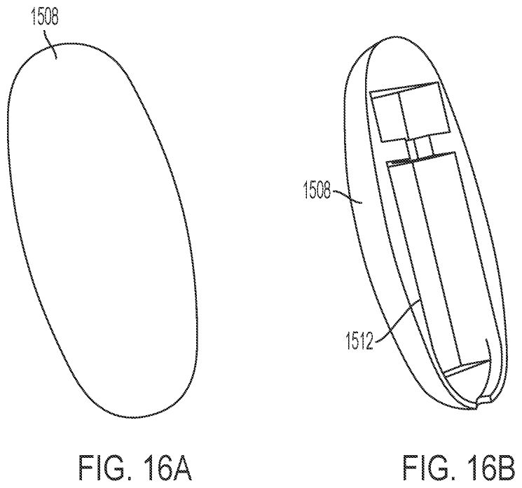

FIG. 12 is a block diagram of an embodiment of a stimulation device 1100 in accordance with disclosed embodiments. The stimulation device includes a processor 1102 and memory 1104. Memory 1104 may be a computer-readable medium such as flash, battery-backed static RAM, or other suitable computer-readable medium. In some embodiments, the memory may be non-transitory. The memory 1104 contains instructions, that when executed by the processor 1102, perform steps in accordance with embodiments of the present invention. For example, in some embodiments, the memory contains instructions, that when executed by the processor, control the operation of the G-spot stimulation function and/or clitoral stimulation vibration function.

The stimulation device may include an onboard input/output interface 1112. This may include one or more input, output, and/or bidirectional pins for control of the stimulation device. User interface 1110 may include one or more buttons (e.g., buttons 122, 124, and 126 of FIG. 1), switches, knobs, or other suitable controls disposed on the stimulation device. The buttons may be configured to create a signal on one or more input pins of the I/O interface 1112. The processor may utilize interrupt service routines or monitoring loops to detect button presses and change the operation of the shaft motor 1115 and/or vibration motor 1114 accordingly. Shaft motor 1115 may be similar to shaft motor 202.

In some embodiments, the processor 1102 controls the speed of the vibration motor 1114 and/or shaft motor 1115. Accordingly, a user may choose a speed appropriate for her comfort level. The higher the speed, generally, the more intense the stimulation. The stimulation device may include non-volatile memory 1105 for storing user settings such as a preferred speed setting and/or mode of operation.

In some embodiments, instead of or in addition to an onboard user interface 1110, the stimulation device may include a wireless communication interface 1118. The wireless communication interface 1118 may include a Bluetooth®, Wi-Fi, or other suitable interface. The wireless communication interface allows pairing with an electronic device 1101 such as a dedicated remote controller, smartphone, tablet computer, or other electronic device.

In some embodiments, the electronic device enables a rich user interface display, allowing for more complex programming options. Wireless communication interface 1118 may be in communication with a transceiver in the electronic device 1101. The stimulation device may be controlled by the user via an application on the smartphone or computer. Some embodiments may not have all of the aforementioned components. The stimulation device further includes a power source 1116. In embodiments, the power source 1116 can include a battery. The battery can be a replaceable, or internally sealed rechargeable battery. In some embodiments, battery may be USB-chargeable, inductively chargeable, or other suitable charging mechanism now known or hereafter developed. It should be recognized that any power source, now known or hereafter developed, may be used. More than one battery may be included in some embodiments. In some embodiments, the stimulation device may be powered by alternating current power, such as 120V or 240V standard household power, with a power adapter comprising voltage regulators to convert the power to an appropriate DC level (e.g., 12V DC).

In some embodiments, the electronic device 1101 may provide a speech control function, in which a user can control the stimulation device 1100. In these embodiments, a user may utter a control word such as “faster” or “slower.” Upon detecting a control word, the electronic device 1101 may issue a command (e.g., via wireless communication protocol such as Bluetooth®) which is received by processor 1102. Processor 1102, in response to receiving the control word, alters the operational speed of the shaft motor 1115 and/or vibration motor 1114 accordingly. In this way, hands-free adjustment of the device 1100 is possible.

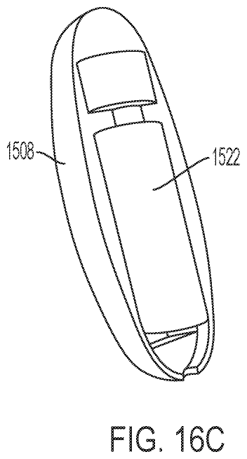

FIG. 13 illustrates usage of a disclosed embodiment in a side position. As can be seen in FIG. 13, a user 1202 has positioned a device 100 in accordance with disclosed embodiments in between her left leg 1207 and her right leg 1205. The concave side surfaces (904 and 906) make the use of the device 100 comfortable as they engage with the generally convex shape of the legs. The device 100 can be used in a hands-free manner, as the legs 1205 and 1207 secure the device 100 in place during use.

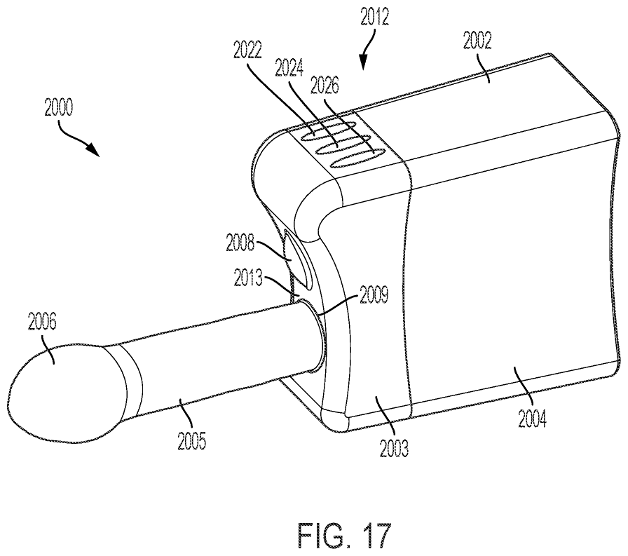

FIG. 14 illustrates usage of a disclosed embodiment in a rocker mode of operation. As can be seen in FIG. 14, a user 1302 is straddling device 100, with her left leg 1307 on one side of the device 100, and her right leg 1305 on the other side of the device 100. The device 100 is placed on floor surface 1324 such that the convex opposing surface 910 is in contact with floor surface 1324. In the rocker mode of operation, the user 1302 can move back and forth with the convex opposing surface 910 moving relative to the floor surface 1324, to create a “rocking” sensation during use.

As can be seen in FIG. 13 and FIG. 14, disclosed embodiments can be used in a hands-free manner. Embodiments have a smooth opposing surface (910 of FIG. 9) that enables use in a rocker mode, where the hands do not contact the apparatus during use.

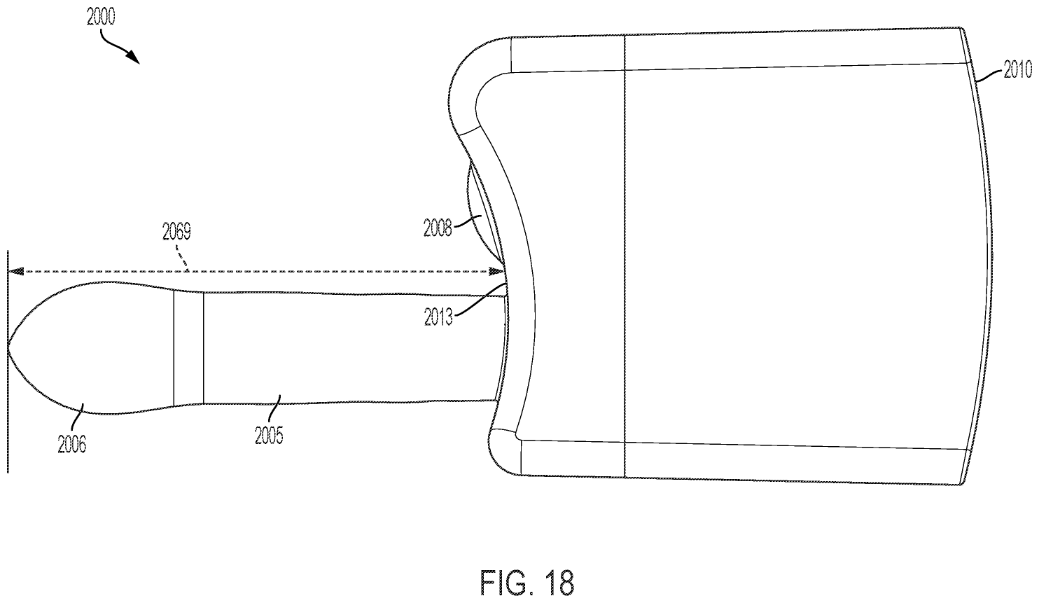

FIG. 15 shows details of a vibration mechanism of disclosed embodiments. In embodiments, a vibration capsule 1508 is installed inside the device proximal to the external massage surface 108 such that it can impart vibrations to the user when the external massage surface 108 is in contact with the body of a user. The vibration capsule includes a vibration motor inside of it to impart the vibrations. In some embodiments, the vibration surface may extend outward from the shaft-side surface such that it can reach the user's clitoris more easily when the device is in use.

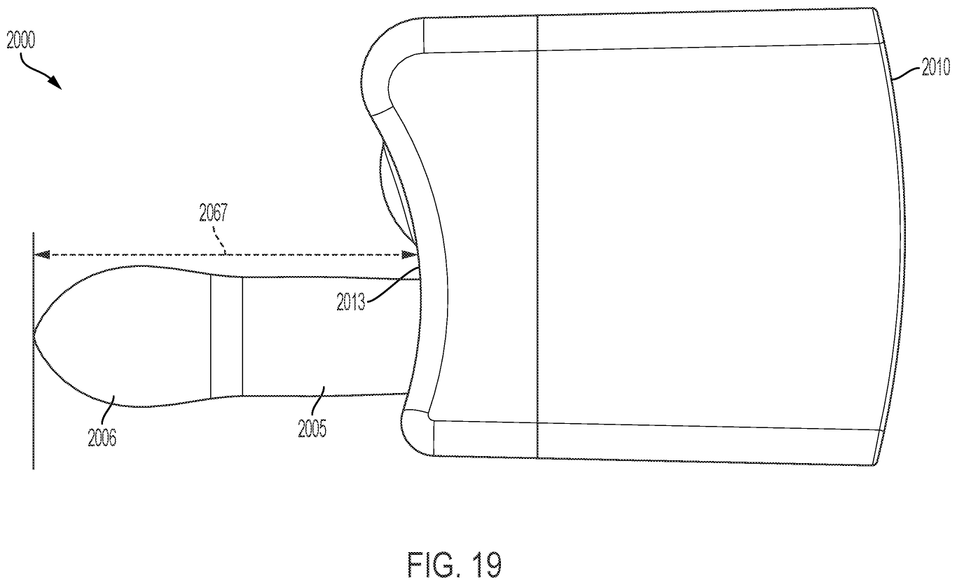

FIG. 16A-16C show details of a vibration capsule of disclosed embodiments. FIG. 16A shows a perspective view of a vibration capsule 1508. FIG. 16B shows a cut-away view of vibration capsule 1508, indicating motor cavity 1512 that is adapted to fit a vibration motor. FIG. 16C shows a cut-away view of a vibration capsule including a vibrator motor 1522. Vibration motor 1522 may be similar to vibration motor 1114. In some embodiments, the vibrator may be replaced with a pulsator, gyrator, or other suitable massage device.

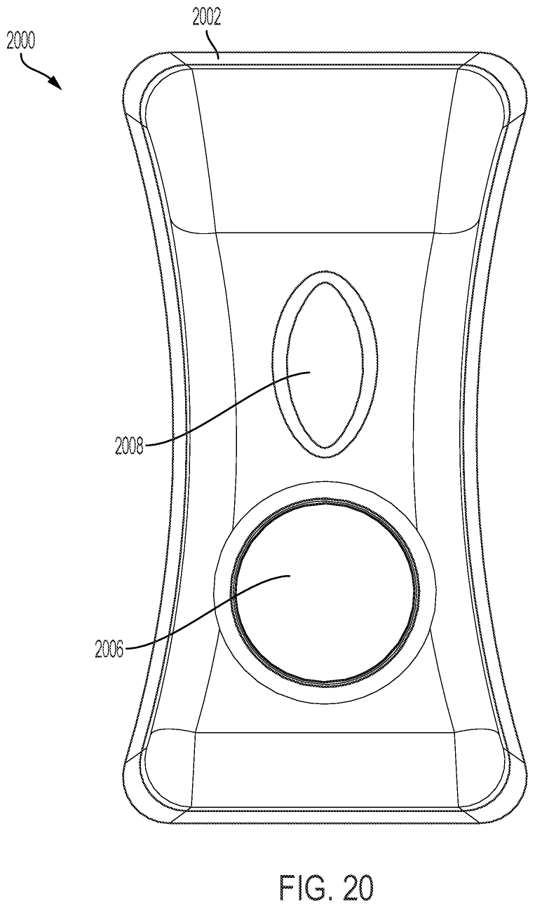

FIG. 17 is a side perspective view of an additional embodiment of the present invention including a thrusting shaft. Device 2000 includes an enclosure 2002. The enclosure 2002 has a side surface 2004. In embodiments, side surface 2004 has a concave shape that is well-suited to conform to the convex shape of the leg of a user. The side surface opposite 2004 is a mirror image of surface 2004. Device 2000 further comprises a shaft 2005 (an internal massage surface), and in some embodiments, an external massage surface 2008, which is similar to 108 in FIG. 1. The shaft 2005 protrudes from a shaft-side surface 2013 of enclosure 2002. The shaft 2005 has tip region 2006 on a distal end of the shaft 2005. In embodiments, the vibration surface 2008 is disposed on the enclosure 2002 between 3 centimeters to 6 centimeters above the shaft attachment point 2009. In this way, in some use cases, when the shaft 2005 is inserted into the vagina of a user, the external massage surface 2008 is disposed on the clitoris region of the user. In some embodiments, the tip region 2006 has a larger diameter than the diameter of the shaft 2005 such as to resemble a human penis. In some embodiments, the external massage surface 2008 is a vibration surface. In some embodiments, instead of vibration, there is pulsation, gyration or other suitable massage pattern or mechanism. In some embodiments, the shaft 105 is disposed within, or includes a flexible exterior surface (sheath). In some embodiments, the sheath is flexible. In some embodiments, the sheath may be elastic. In some embodiments, the sheath is made of silicone, plastic, or another, or other suitable material.

The enclosure may further include a user interface 2012. In some embodiments the user interface may include one or more buttons, indicated as 2022, 2024, and 2026. In embodiments, button 2022 is an on/off button for the device 2000. In embodiments, button 2024 is a start/stop button for the external massage surface 2008. In embodiments, button 2026 is a start/stop button for the thrusting operation of shaft 2005. By use of the device 2000, the thrusting motion of shaft 2005 can be used to allow a person with a vagina to simulate sexual activity with a penis. Device 2000 is similar to device 100 of FIG. 1, with a key difference being the motion of the shaft 2005, as will now be described in additional detail.

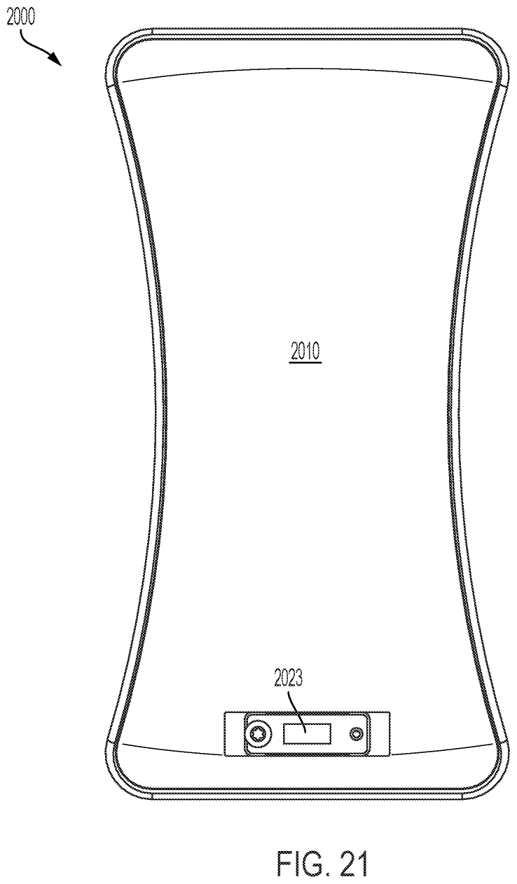

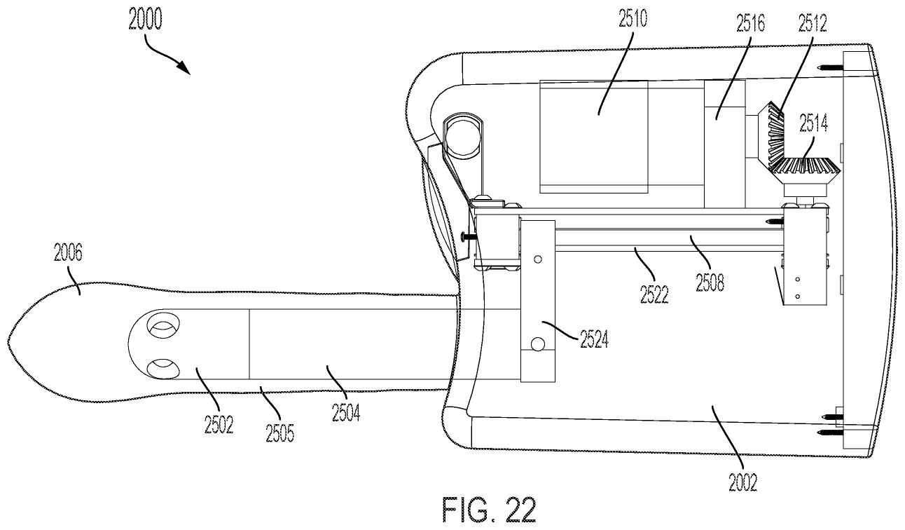

FIG. 18 is a side view of the device 2000 of FIG. 17 shown with the shaft in an extended configuration. FIG. 19 is a side view of the device 2000 of FIG. 17 shown with the shaft in a retracted configuration. Referring again to FIG. 18, the shaft 2005 is extended such that the shaft length 2069 is a length as measured from the shaft-side surface 2013 to the end of tip 2006. Referring now to FIG. 19, the shaft 2005 is retracted such that the shaft length 2067 is a length as measured from the shaft-side surface 2013 to the end of tip 2006, where length 2069 is greater than length 2067. In embodiments, length 2069 ranges from 20 centimeters to 25 centimeters, and length 2067 ranges from 13 centimeters to 18 centimeters. These measurements are examples, and other suitable ranges are included within the scope of the invention.

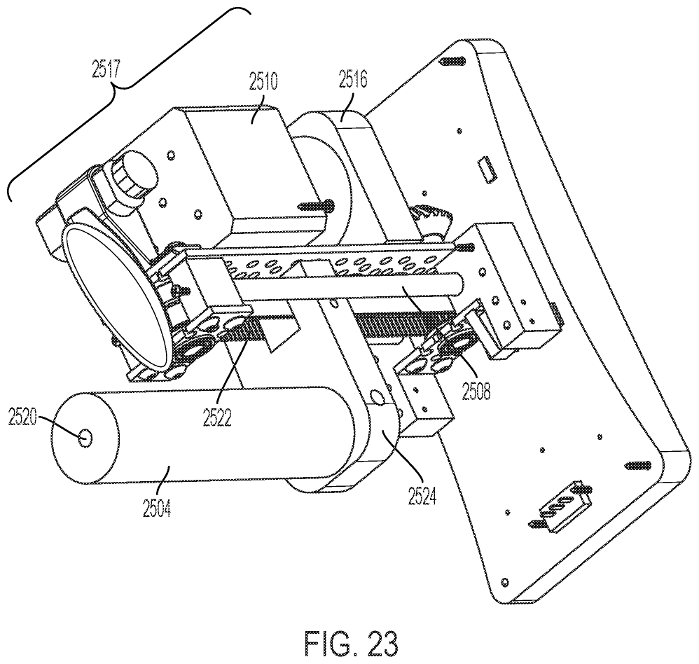

FIG. 20 is a front view of the device 2000 of FIG. 17. In this view, the external massage surface 2008 and tip 2006 are visible, protruding from enclosure 2002.

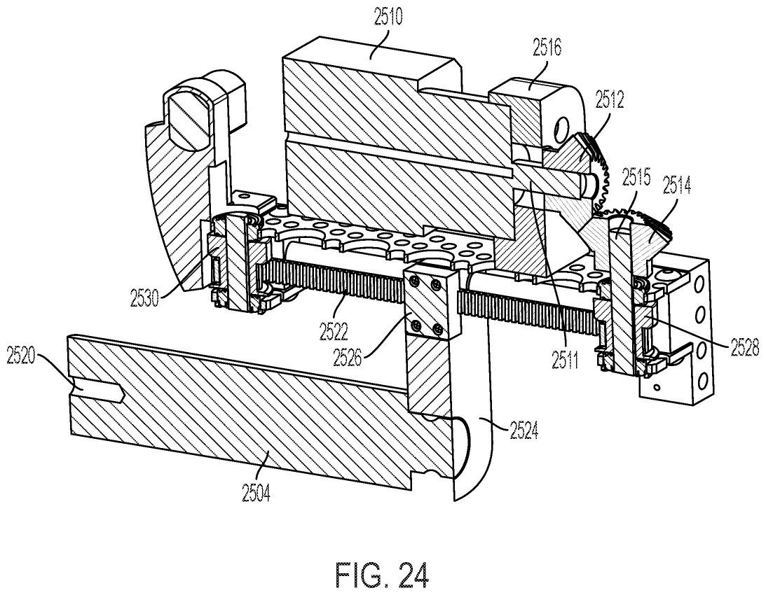

FIG. 21 is a rear view of the device 2000 of FIG. 17 showing opposing surface 2010. In embodiments, opposing surface 2010 may be convex, similar to surface 910 of FIG. 10. In this view, a charging port 2023 is shown. Charging port 2023 may be used to charge an internal rechargeable battery. In some embodiments, charging port 2023 may be a USB-A., USB-C, mini-USB, micro-USB, or other suitable connection type. In some embodiments, the charging port may be on another location of the device. In some embodiments, the device 2000 may have a removeable battery such as shown in FIG. 11.

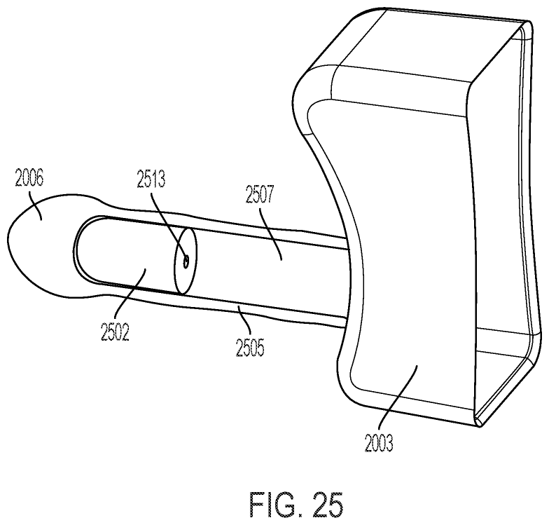

FIG. 22 is a side cutaway view of the device 2000 of FIG. 17 showing internal components. A motor 2510 is affixed within the enclosure 2002. In embodiments, the motor 2510 may be a stepper motor. In some embodiments, the motor 2510 may further include an integrated position encoder. The motor 2510 is affixed in place via motor mount 2516. The motor 2510 is mechanically coupled to a first miter gear 2512 which engages with a second miter gear 2514. The second miter gear 2514 moves a belt that is mechanically coupled to the shaft 2504 via a shaft mount 2524. The shaft 2504 is mechanically coupled to a tip slug 2502 that is integrated into the tip 2006 via a molding process to fabricate a sheath 2505 that is integrated with the tip 2006 and tip slug 2502. The motor 2510 operates in an alternating motion to cause gear 2512 and gear 2514 to operate in an alternating motion. This causes belt 2522 to move back and forth. The belt 2522 is mechanically coupled to the shaft 2504 via shaft mount 2524. Sheath 2505 may be made of silicone, plastic or another suitable material.

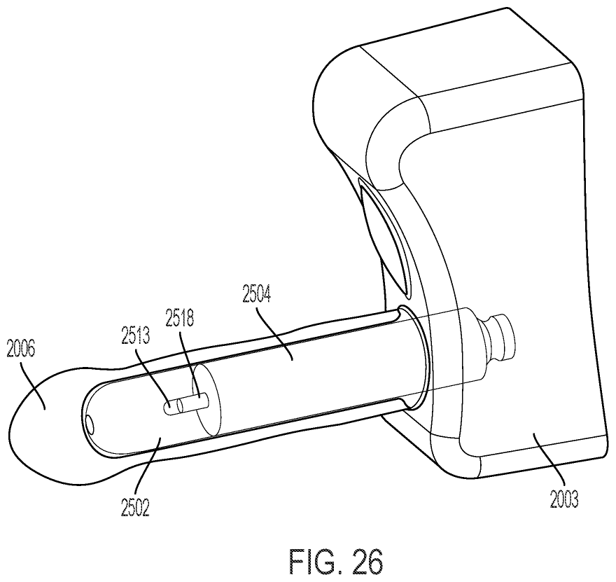

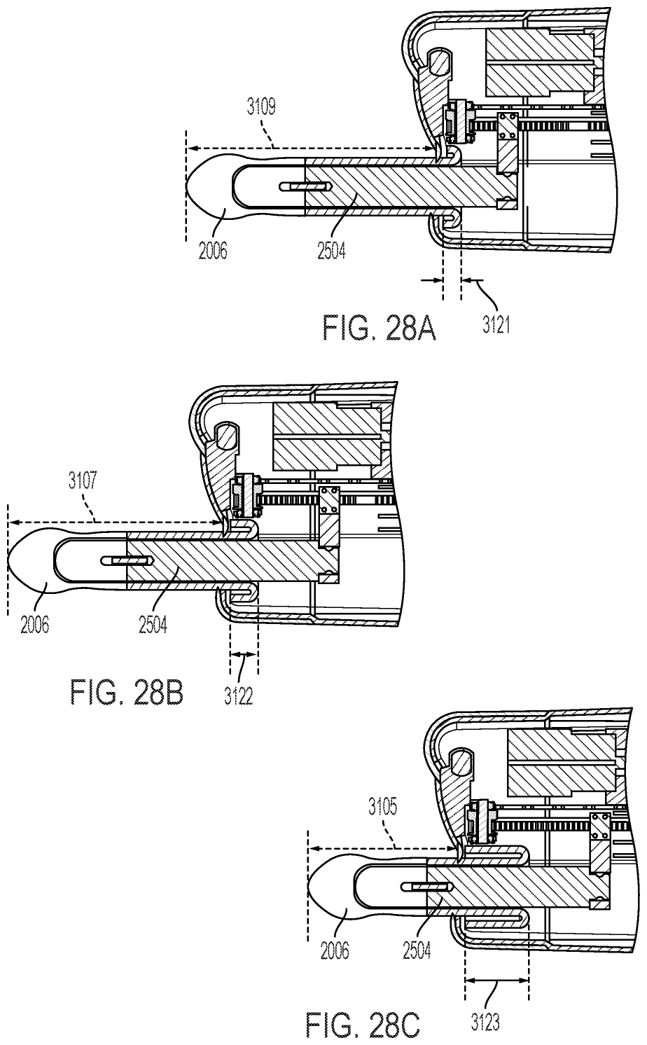

FIG. 23 shows details of the thrust driver 2517 of disclosed embodiments. In this view, the motor 2510 is visible, and shown affixed to motor mount 2516. The belt 2522 is mechanically coupled to the shaft mount 2524. The shaft 2504 is affixed to the shaft mount 2524. A threaded hole 2520 is formed at the tip of the shaft 2504. This threaded hole can be used to couple the shaft 2504 to the tip slug 2502 (shown in FIG. 25). As the belt moves, the shaft mount 2524 slides along linear guide shaft 2508. In some embodiments, there may be multiple linear guide shafts similar to guide shaft 2508 to enable a smooth reciprocal motion of the shaft 2504. The motor 2510, belt 2522, and shaft mount 2524, along with any additional intermediate components comprise a thrust driver 2517. The thrust driver 2517 causes the shaft 2504 to operate in a thrusting (linear reciprocating) motion that can simulate intercourse with a penis. In embodiments, the motor 2510 can be configured to cause the thrust driver to operate in a predetermined range of motion and/or predetermined speed. In this way, a user can select a desired amount of thrust (penetration) and/or speed (rate of linear reciprocating motion (thrusting)) during use of the device. In some embodiments, the range of motion ranges from 2 centimeters to 15 centimeters. In some particular embodiments, the range of motion ranges from 4 centimeters to 11 centimeters. The range of motion may be user-adjustable utilizing the user interface 1110 or other suitable user interface. In some embodiments, the rate of linear reciprocating motion may range from 0.5 Hertz to 5 Hertz. In some particular embodiments, the rate of linear reciprocating motion may range from 1 Hertz to 3 Hertz. The rate of linear reciprocating motion may be user-adjustable utilizing the user interface 1110 or other suitable user interface.

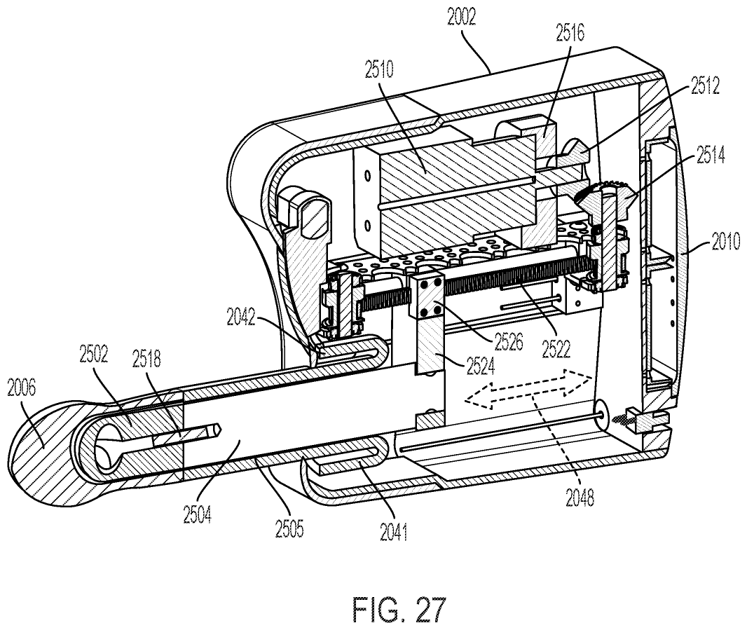

FIG. 24 is a sectional view showing additional details of the thrusting driver of disclosed embodiments. In this view, the motor 2510 is shown affixed to motor mount 2516 with motor shaft 2511 protruding through the motor mount 2516 to attach to gear 2512. Gear 2512 engages gear 2514, which is affixed to axle 2515, which is affixed to belt pully 2528. The belt 2522 is disposed around the belt pully 2528 and second belt pully 2530. The belt clamp 2526 clamps the shaft mount 2524 to the belt 2522. During operation, the belt 2522 moves back and forth, causing the shaft 2504 to move back and forth along with the belt 2522.

FIG. 25 shows details of the sheath 2003 with integrated thruster slug 2502. In embodiments, sheath 2003 is an integrated unit that includes tip 2006, tip slug 2502 which is molded into the tip 2006, and shaft cavity 2507 which is adapted to receive the shaft 2504 (FIG. 23). A threaded hole 2513 at the rear side of the tip slug 2502 is used to mechanically couple the tip slug 2502 to the shaft 2504.

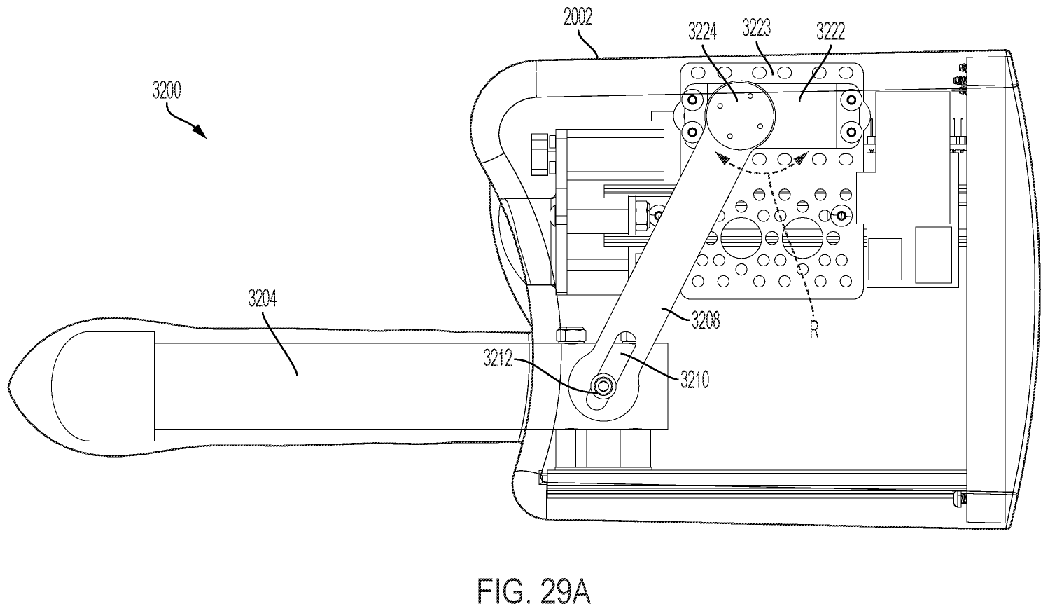

FIG. 26 shows details of shaft installation in disclosed embodiments. In this view, it can be seen that the shaft 2504 is mechanically coupled to the tip slug 2502 via threaded shaft 2518. Threaded shaft 2518 engages with threaded hole 2513 of the tip slug 2502 and also engages with the threaded hole 2520 (FIG. 23) of the shaft 2504, thereby mechanically coupling the shaft 2504 to the tip slug 2502.

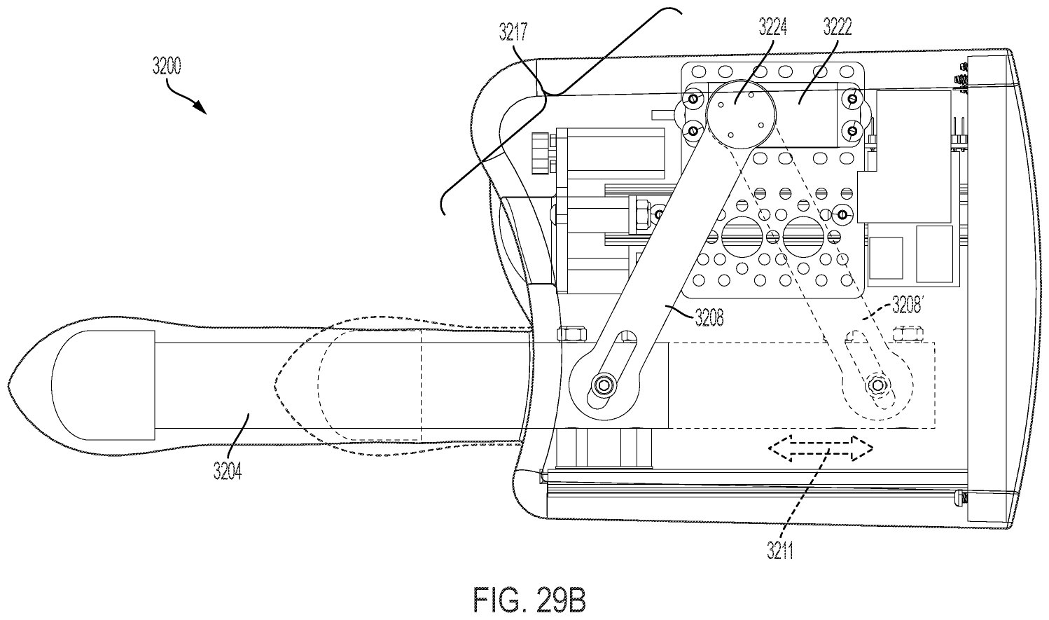

FIG. 27 is a sectional view showing additional details of the thrusting driver of disclosed embodiments. In this sectional view, it can be seen that the tip slug 2502 is coupled to the shaft 2504 via threaded shaft 2518. The belt clamp 2526 clamps the belt 2522 to the shaft mount 2524. As the motor 2510, secured by motor mount 2516, turns gear 2512 in alternating directions, it turns gear 2514 in alternating directions, causing the shaft 2504 to move in the directions indicated by arrow 2048. The tubular end of the sheath, indicated 2042, is affixed to the enclosure 2002. As the shaft 2505 is pulled towards the opposing surface 2010, a portion of the sheath folds back as indicated at 2041. In this way, the sheath accommodates the thrusting motion of the shaft 2504 such that the sheath 2505 fits snugly around the shaft 2504 as the shaft moves in the reciprocal motion indicated by arrow 2048 during operation.

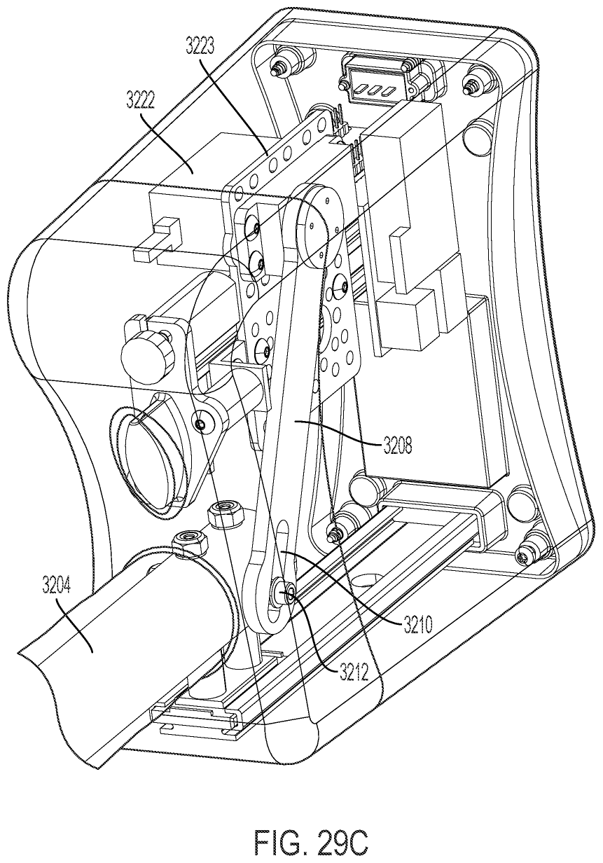

FIGS. 28A-28C show a motion sequence in sectional view for embodiments of the present invention. FIG. 28A shows the shaft 2504 in a fully extended configuration. FIG. 28B. shows the shaft 2504 in a configuration in between fully extended and fully retracted positions. FIG. 28C shows the shaft 2504 in a retracted configuration. Referring again to FIG. 28A, the shaft 2504 is fully extended to create a shaft length 3109 (measured in the same manner as shown in FIG. 18), from the shaft side of the enclosure to the end of the tip 2006. Section 3121 of the sheath is folded. The sheath is flexible to allow this folding. FIG. 28B shows shaft length 3107, where shaft length 3107 is less than shaft length 3109. Section 3122 of the sheath is folded, where section 3122 is larger than section 3121 of FIG. 28A. FIG. 28C shows shaft length 3105, where shaft length 3105 is less than shaft length 3107. Section 3123 of the sheath is folded, where section 3123 is larger than section 3122 of section 28B. In some embodiments, instead of folding the sheath may be elastic to stretch. In some embodiments, the sheath may be elastic and flexible.

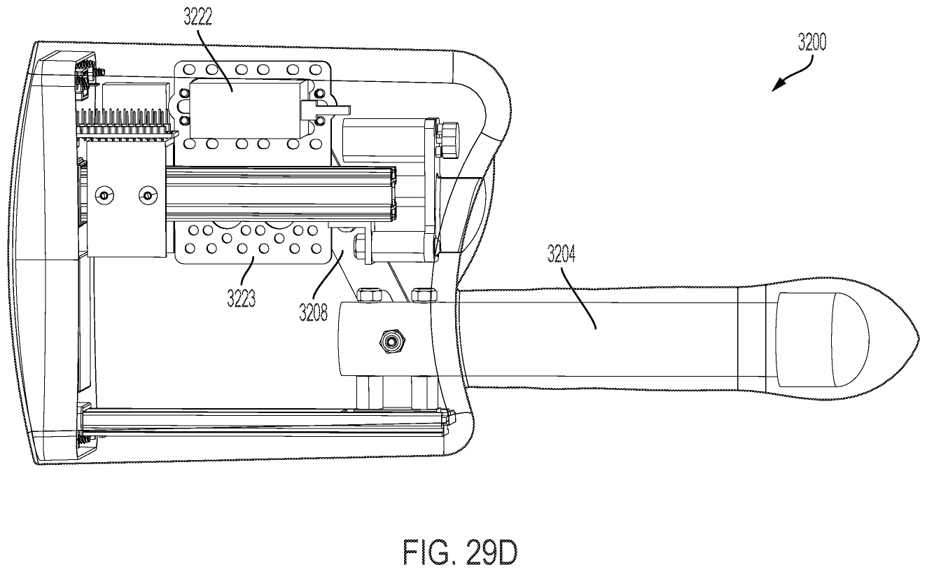

FIGS. 29A-29D show a thrusting mechanism in accordance with additional embodiments of the present invention. FIG. 29A shows a side cutaway view of a device 3200 in accordance with alternative embodiments. Device 3200 is similar to the device shown in FIG. 24, with the key difference being the use of a servo motor and arm in place of the belt shown in FIG. 24. Referring again to FIG. 29A, servo motor 3222 is affixed to bracket 3223 that is installed within enclosure 2002. The servo motor 3222 has cog 3224 that is mechanically coupled to the servo motor 3222. Arm 3208 is affixed to the cog 3224. The servo motor 3222 is configured to provide rotational motion to the cog 3224. The amount of rotation is indicated by angle R. In embodiments, angle R can vary from 20 degrees to 80 degrees. In embodiments, the servo motor 3222 can be configured to cause the thrust driver to operate in a predetermined range of motion and/or predetermined speed. In this way, a user can select a desired amount of thrust (penetration) and/or speed (rate of linear reciprocating motion (thrusting)) during use of the device (for example, via a user interface screen on device 1101 in FIG. 12). The arm 3208 is mechanically coupled to the shaft 3204 via slot 3210 in the arm 3208 that is configured and disposed engage with a pin 3212 on an outer surface of shaft 3204. In some embodiments, the angle R, and/or speed of the motor 3222 can be adjustable by the user (e.g., though user interface 1110). FIG. 29B shows example motion of the device 3200. The arm 3208 can move from its original position to position 3208′ in a reciprocating motion, causing shaft 3204 to move back and forth in the direction indicated by arrow 3211.

The motor 3222, cog 3224, and arm 3208, along with any additional intermediate components comprise a thrust driver 3217. The thrust driver 3217 is used to cause the shaft 3204 to operate in a thrusting (linear reciprocating) motion that can simulate intercourse with a male partner. FIG. 29C shows a perspective view of the embodiment of FIG. 29A. FIG. 29D shows an opposite side view of the embodiment shown in FIG. 29A.

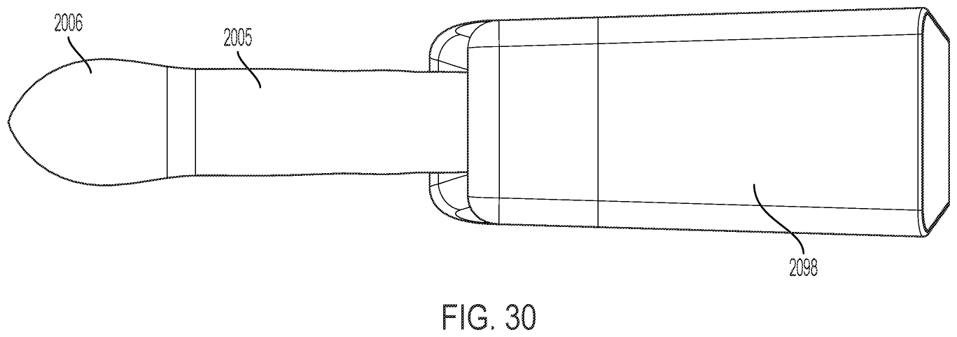

FIG. 30 shows a bottom-up view of the embodiments. Bottom surface 2099 is in view, as well as shaft 2005 and tip 2006. The embodiment of FIG. 1. may have a similar bottom surface.

As can now be appreciated, disclosed embodiments provide a novel stimulation device. The device includes a thrusting phallic shaft, a clitoral stimulator, and an enclosure including two concave sides, and a convex opposing surface that supports a rocker mode of operation. It should be recognized that the body can be used with any type of massage device, and those shown as examples. The embodiments disclosed in FIGS. 20-30 may have similar components and operation as shown in FIG. 12, and used in a manner similar to as shown in FIG. 13 and FIG. 14.

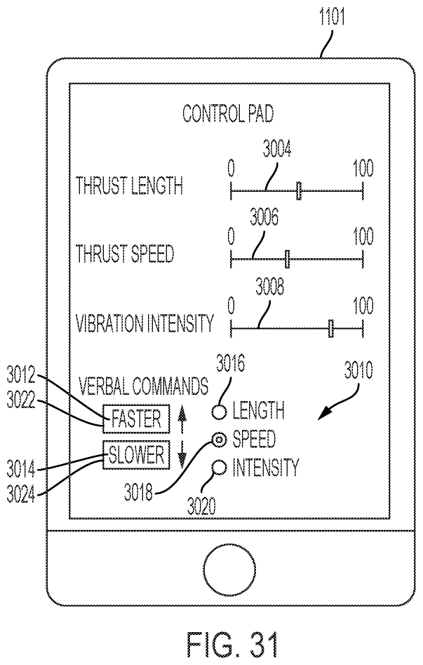

FIG. 31 shows a close-up view of an example user interface on remote device 1101, which may be rendered in accordance with embodiments of the invention. In some embodiments, the remote device may have a touch screen, or use a button, mouse, or keyboard for input. As shown, there is a user interface containing slide bars for adjusting thrust length 3004, thrust speed 3006, and vibration intensity 3008. There is also a menu 3010 for speech control to associate verbal commands “faster” 3012 or “slower” 3014 with radio buttons 3016, 3018, and 3020, corresponding to length, speed or intensity, respectively. In some embodiments, “faster” and “slower” are examples, and a user can enter custom words into fields 3012 and 3014 corresponding to an increase or decrease in the controlled preference. In the example, thrust length is set to about 50%, thrust speed is set to about 45% and vibration intensity is set to about 75%. Command words are set to control speed as radio button 3018 is selected. In embodiments, the user interface may be a touch screen, mouse, or keyboard controlled. More, fewer, or different controls may be included in implementations.

Unless otherwise noted herein, components of embodiments may be made of plastic, silicone, metal, composite, or another suitable material.

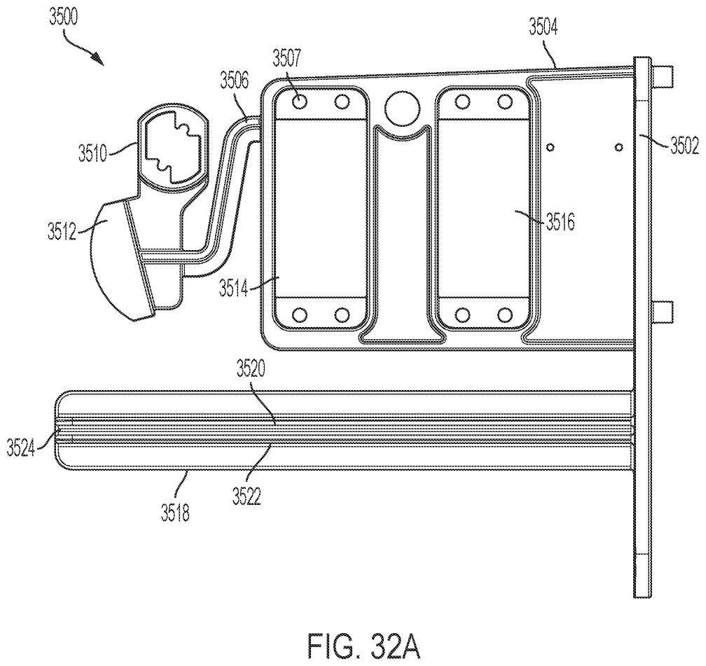

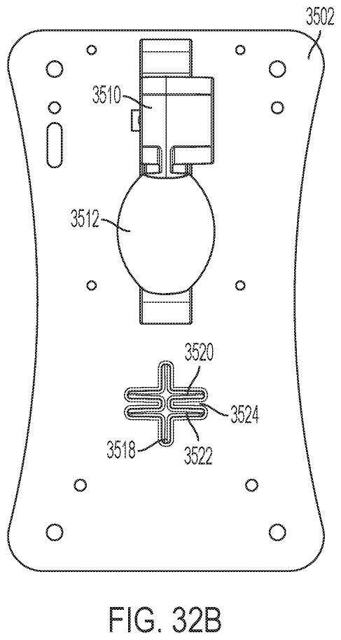

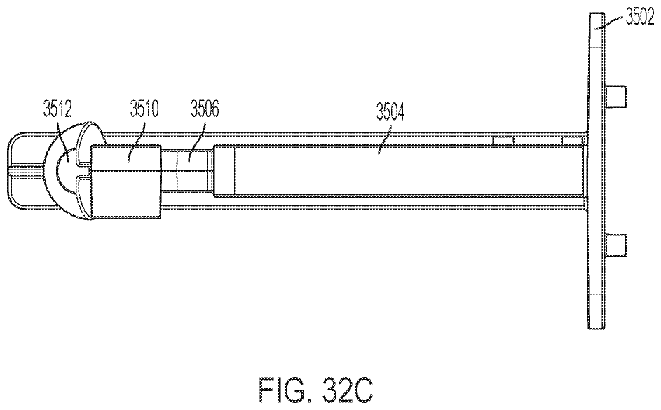

FIG. 32A shows a side view of an internal mount bracket 3500 in accordance with additional embodiments of the present invention. FIG. 32B shows a front view of the internal mount bracket of FIG. 32A. FIG. 32C shows a top-down view of the internal mount bracket of FIG. 32A. In embodiments, mount bracket 3500 may be comprised of a single piece of injection-molded plastic, or it may be constructed from multiple pieces. The mount bracket 3500 includes a backplate 3502. A motor plate 3504 is affixed orthogonally to the backplate 3502. The motor plate 3504 comprises a first opening 3514 and a second opening 3516. The first opening 3514 and second opening 3516 are each sized to accommodate a servo motor. Thus, the mount bracket 3500 can accommodate two servo motors. The first opening 3514 and second opening 3516 each have a plurality of mounting holes, indicated generally as 3507, for securing a motor in each opening (3514, 3516).

A shaft track 3518 is affixed orthogonally to the backplate 3502. The shaft track 3518 comprises a first rail 3520 and a second rail 3522 that extend longitudinally along the shaft track 3518, forming groove 3524. The groove is used for moveably attaching a thrustable shaft to the shaft track 3518.

A vibration head (also “massage head”) 3512 is affixed to an extension arm 3506. The extension arm 3506 is connected to the motor plate 3504. A vibration motor bracket 3510 is formed in the mount bracket 3500, near the vibration head 3512. The extension arm 3506 is designed to have some flex to allow bending when the vibration head is pressed against a user's body.

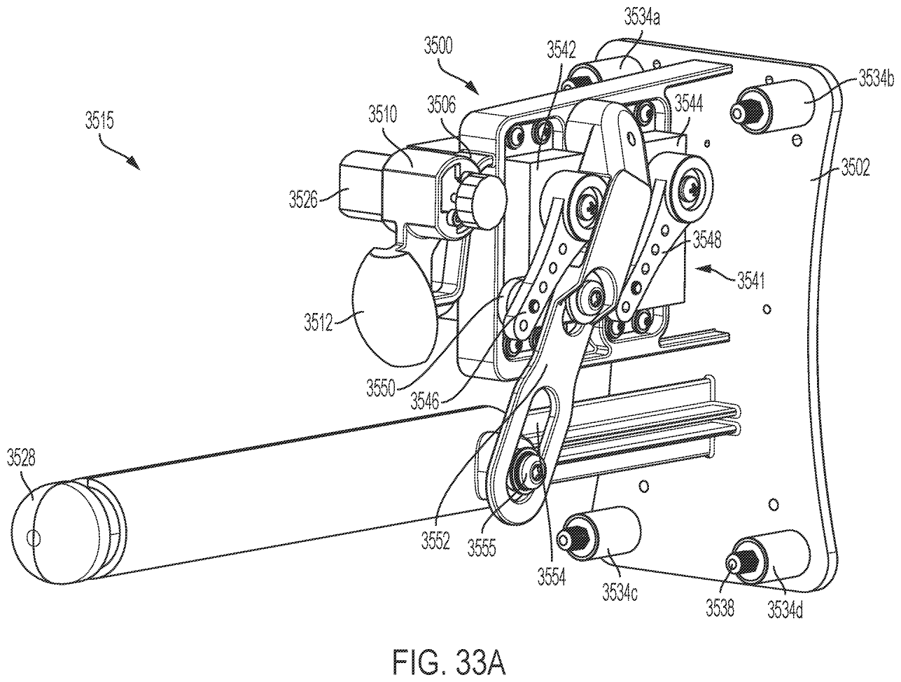

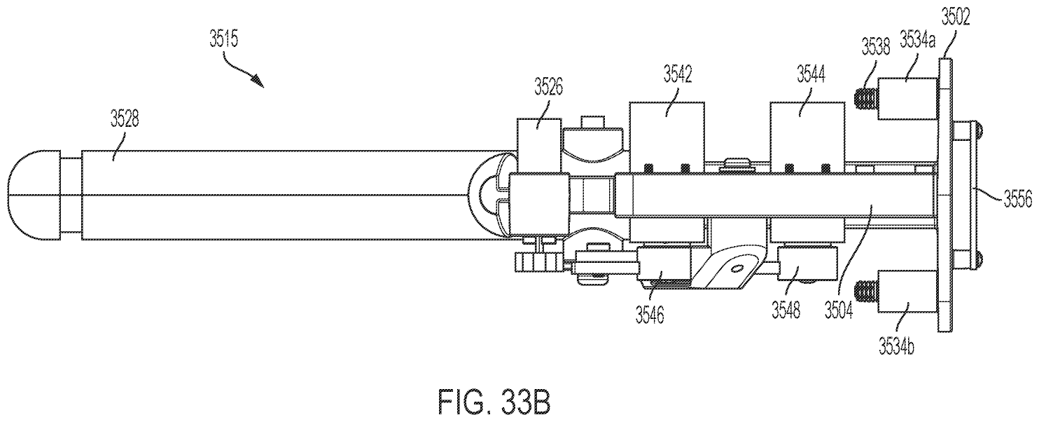

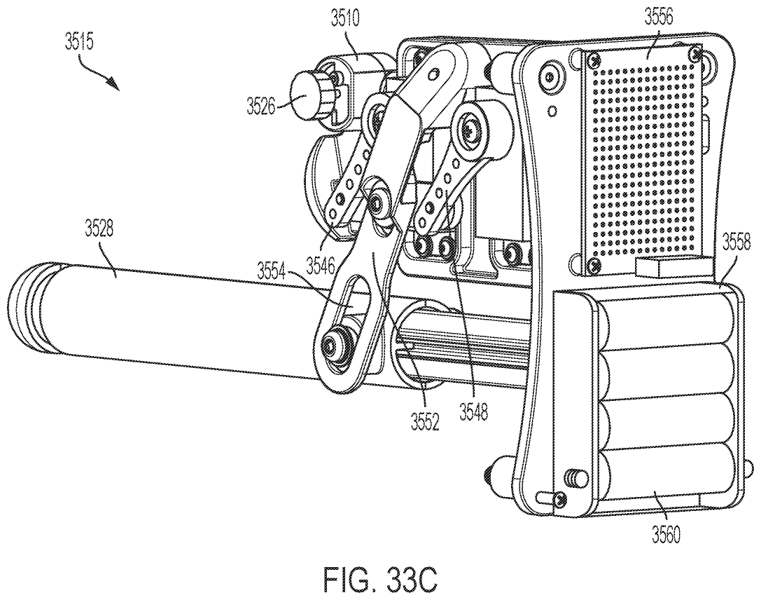

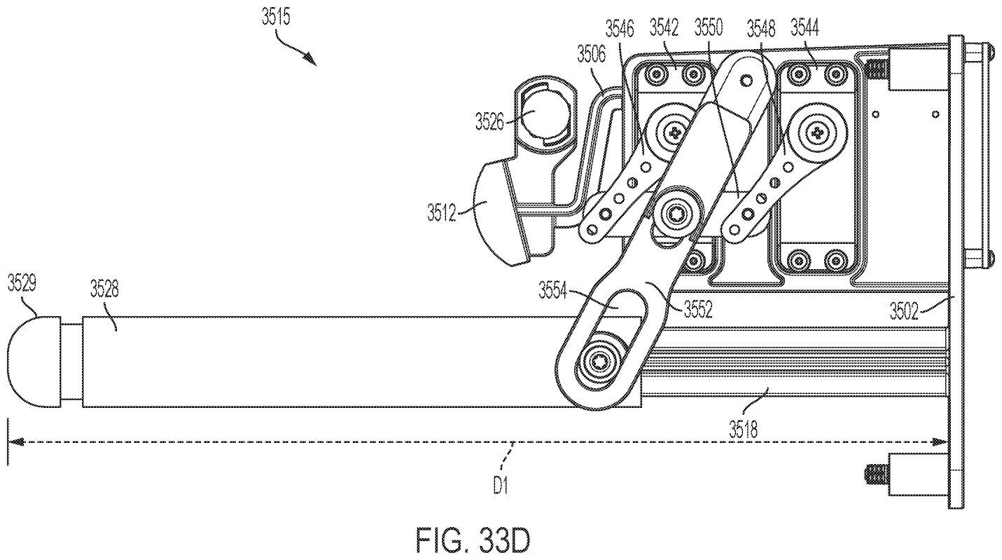

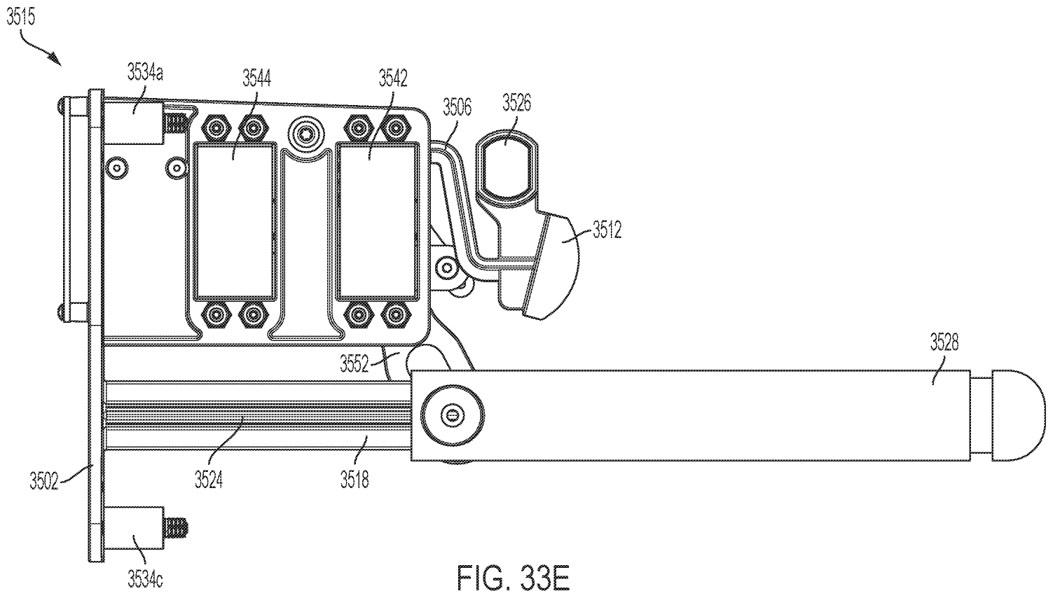

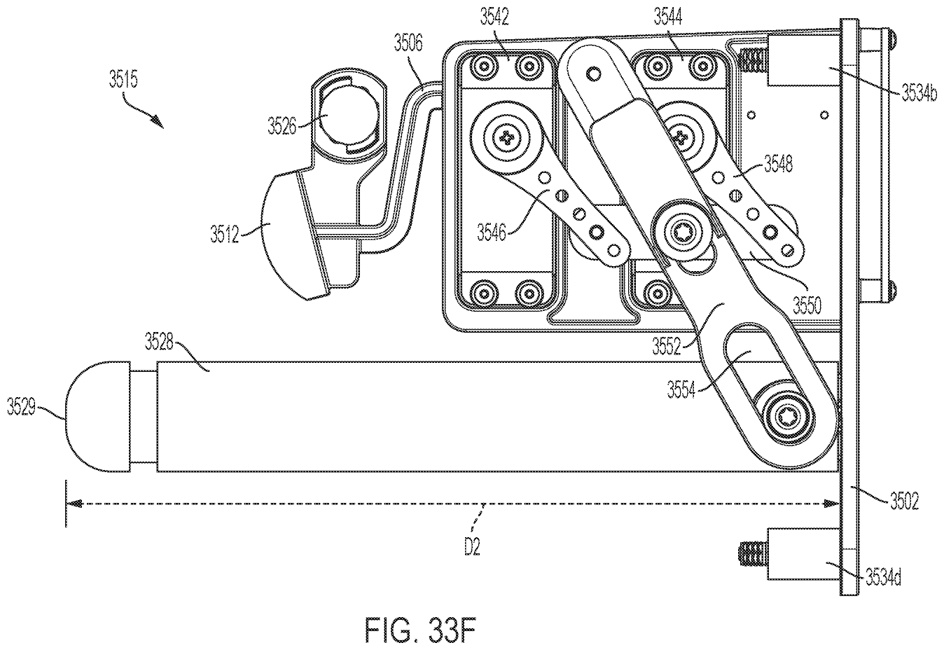

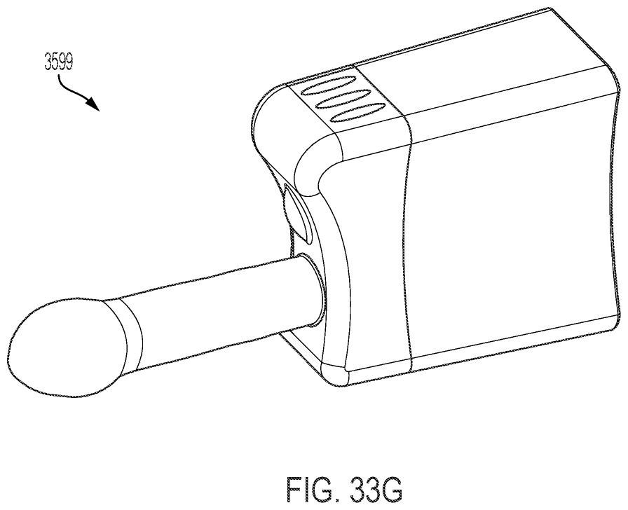

FIG. 33A is a front perspective view of an assembly 3515 using the internal mount bracket of FIG. 32A. A first motor 3542 and a second motor 3544 are installed in the mount bracket 3500. The use of two motors enables sufficient power in a compact space appropriate for a personal-use device. A first pivot arm 3546 is coupled to the first motor 3542. A second pivot arm 3548 is coupled to the second motor 3544. A pivot arm coupler 3550 is moveably connected between the first pivot arm 3546 and the second pivot arm 3548. The pivot arm coupler 3550 is also mechanically coupled to shaft link 3552. Shaft 3528 is coupled to shaft link 3552 via slot 3554 and shaft nut 3555. In embodiments, the first motor 3542 and second motor 3544 are configured to operate in a synchronized manner, such that they move the same amount in the same direction at all times, combining the power of each motor to enable a sufficiently strong thrusting mechanism of shaft 3528. Thus, embodiments can include a first servo motor; and a second servo motor, where the second servo motor is mechanically coupled to the first servo motor. In embodiments, a driver 3541 comprises a first pivot arm coupled to the first servo motor; a second pivot arm coupled to the second servo motor; and a pivot arm coupler, connected between the first pivot arm and the second pivot arm. Embodiments can include an enclosure, comprising an internal mount bracket affixed to an interior surface of the enclosure, where the first servo motor and second servo motor are affixed to the internal mount bracket. In embodiments, the first servo motor and second servo motor are mounted in a motor plate.

In embodiments, a vibration motor (also called “massage motor” herein) 3526 is installed in vibration motor bracket 3510, and provides vibration to vibration head 3512 during operation. Thus, embodiments include a vibration motor coupled to the extension arm 3506, via the vibration motor bracket 3510. In some embodiments, instead of a vibration motor, the massage motor may be a pulsation motor, gyration motor, or other suitable massage motor.

FIG. 33B is a top-down view of the assembly 3515 of FIG. 33A. In this view, electronics module 3556 is visible. The electronics module 3556 includes a processor, memory, non-volatile memory, communication interface, input/output interface, and/or other electronic components, such as previously described and shown in FIG. 12.

FIG. 33C is a rear perspective view of the assembly 3515 of FIG. 33A. In this view, the electronics module 3556 is visible, along with battery compartment 3558. In some embodiments, battery compartment 3558 may accommodate one or more removable batteries, indicated generally as 3560. In embodiments, the removeable batteries may be rechargeable batteries. Other embodiments may have a sealed rechargeable battery (or batteries) instead of removeable batteries. In some embodiments, four AA batteries are used as the power source for the device.

FIG. 33D is a side view of the assembly 3515 of FIG. 33A in an extended position. In this view, the shaft 3528 is in a position such that it is extended, and the tip 3529 is at a distance D1 from the backplate 3502. FIG. 33E is an opposite-side view of the assembly of FIG. 33A in an extended position. In this view, it can be seen that the opposite side also has a track groove 3524 for guiding the motion of shaft 3528. Thus, in embodiments, the internal mount bracket further comprises a shaft track, wherein the thrustable shaft is configured and disposed to move along the shaft track.

Also visible in FIG. 33E, are the shock mounts, indicated generally as 3534a and 3534c. Additional shock mounts 3534b, 3534d are shown in FIG. 33A and other views herein. The shock mounts 3534a-3534d may be comprised of rubber cylinders installed on mating posts. The mating posts mate with the enclosure, and the shock mounts serve to reduce imparting vibrations from the motors and other moving parts to the enclosure. In this way, a quieter and more comfortable operation of devices of disclosed embodiments is achieved.

FIG. 33F is a side view of the assembly of FIG. 33A in a retracted position. In this view, the shaft 3528 is in a position such that it is retracted, and the tip 3529 is at a distance D2 from the backplate 3502, where D2 is less than D1 of FIG. 33D. In some embodiments, the difference between D1 and D2 ranges from 10 centimeters to 15 centimeters.

FIG. 33G is a side perspective view of an example exterior 3599 that would house the assembly of FIGS. 33A-33F. As shown, FIG. 13G includes substantially the same elements of FIG. 17.

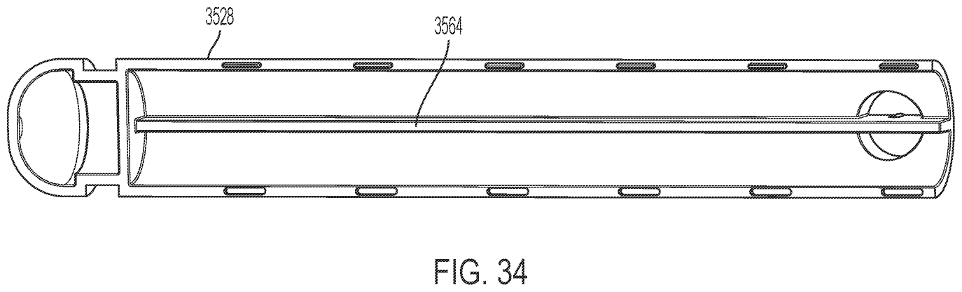

FIG. 34 shows a cross-section of the shaft 3528. In this view, shaft rail 3564 is visible, extending longitudinally along the shaft 3528.

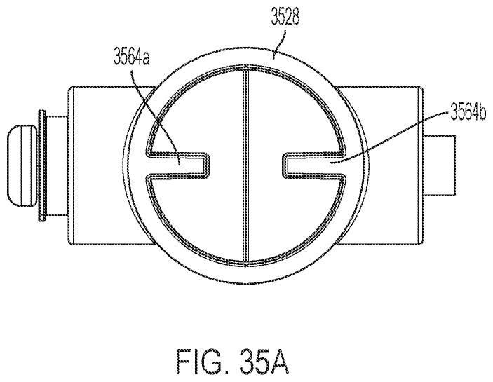

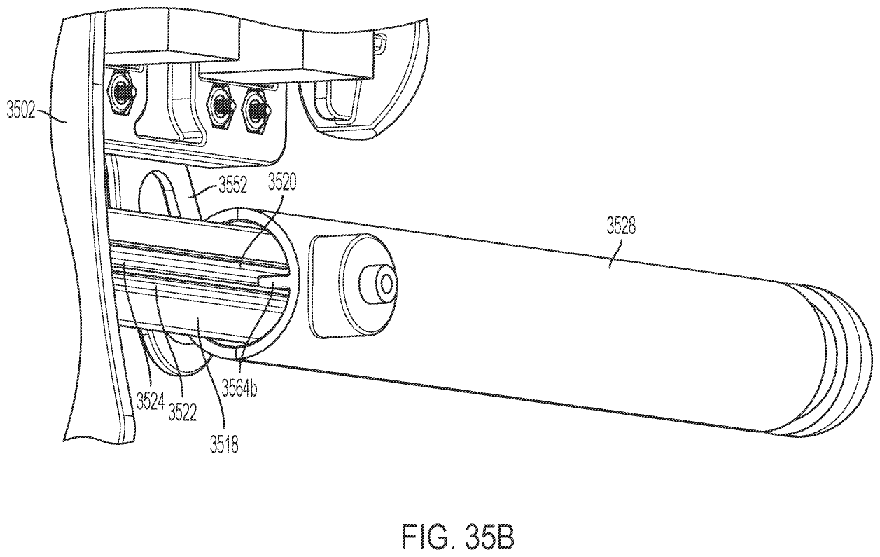

FIG. 35A shows a rear view of the shaft 3528. In this view, two shaft rails, indicated as 3564a and 3564b, are affixed to an interior of the shaft 3528, to engage with grooves of the shaft track.

FIG. 35B shows a rear view of the shaft 3528 as installed on the shaft track 3518. In this view, it can be seen that the shaft rail 3564b is disposed in groove 3524 formed by first rail 3520 and second rail 3522.

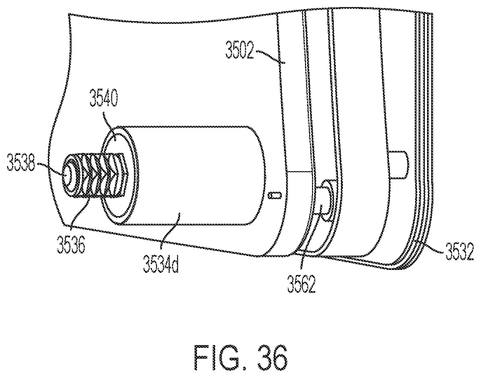

FIG. 36 shows details of an example of the shock mounts. In this view, a shock mount 3534d is seen, placed on a mating post 3538. A nut 3536 may press against a washer 3540, securing the shock mount 3534d against the backplate 3502. A second set of shock mounts, indicated generally as 3562, may be disposed between the backplate 3502 and the rear cover 3532. The shock mounts serve to reduce vibration imparted to the enclosure, thereby improving comfort and enjoyment while using the device.

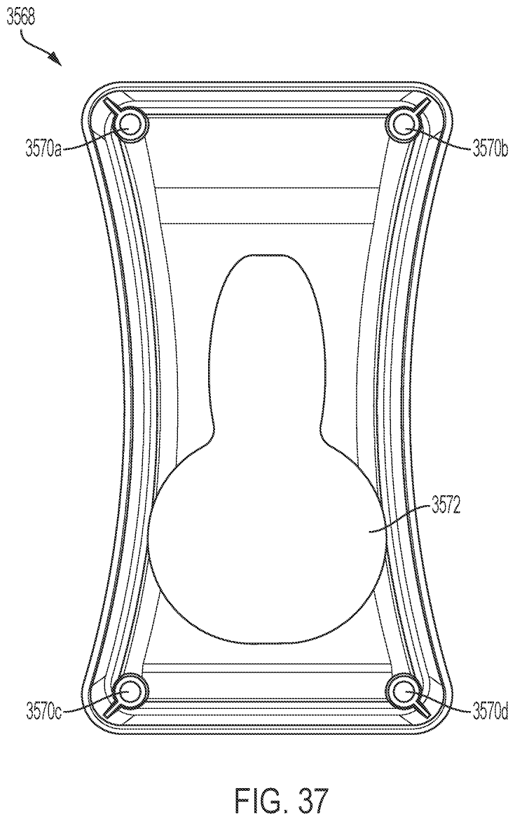

FIG. 37 shows an interior view of the front enclosure 3568. In this view, a front cavity 3572 is visible. It accommodates the shaft and vibration head of the device. A plurality of mounting receptacles, indicated generally as 3570a-3570d, are affixed to the front enclosure 3568. The mounting receptacles 3570a-3570d are positioned to engage with the shock mounts 3534a-3534d shown in previous FIGs.

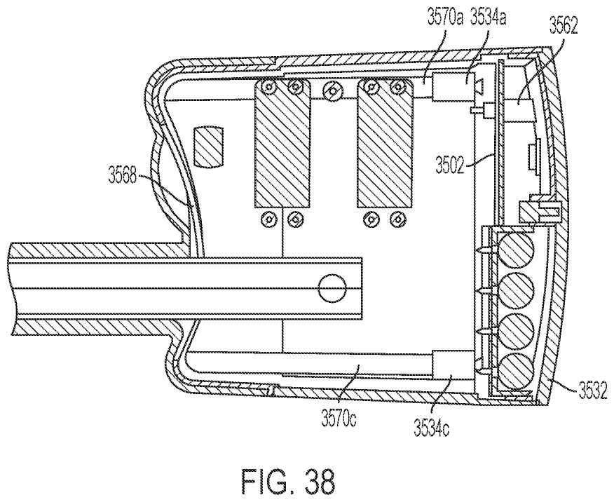

FIG. 38 is a cross section showing the configuration of the shock mounts for the front enclosure. In this view, mounting receptacles 3570a, 3570c of front enclosure 3568 are visible. Each shock mount 3534a, 3534c is positioned adjacent to, and mechanically coupled with, a corresponding mounting receptacle 3570a, 3570c. A second shock mount 3562, disposed between the backplate 3502 and the rear cover 3532 is also visible in this view. In embodiments, there can be multiple instances of shock mount 3562. In embodiments, multiple layers of shock mounts can be used. The shock mounts 3534a, 3534c (as well as the others) may comprise a first layer of shock mounts, and the shock mounts 3562 may comprise a second layer of shock mounts. In embodiments, more or fewer shock mounts may be included.

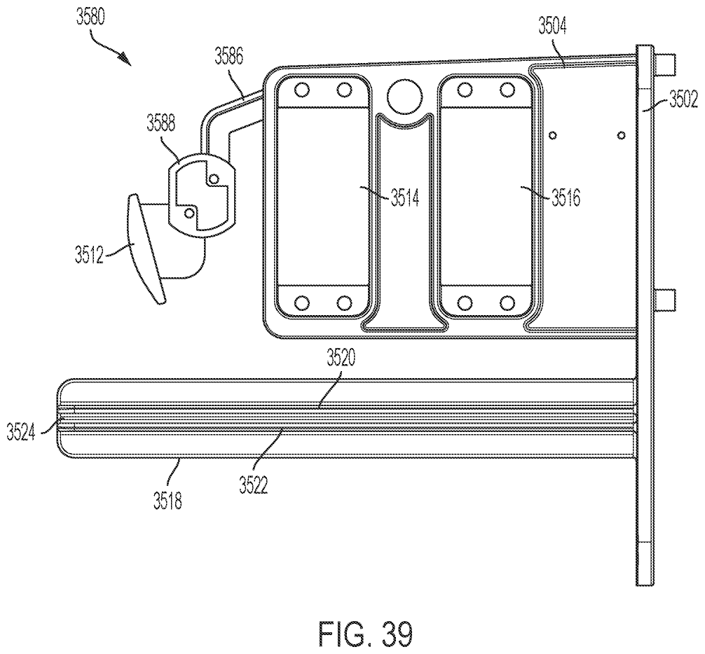

FIG. 39 shows a side view of an internal mount bracket 3580 in accordance with additional embodiments of the present invention. Internal mount bracket 3580 is similar to internal mount bracket 3500 shown in FIG. 32A with regard to the shaft track 3518 and motor plate 3504. The main difference between internal mount bracket 3580 and internal mount bracket 3500 of FIG. 32A is the configuration of the extension arm. In FIG. 39, extension arm 3586 connects between the motor plate 3504 and vibrator motor bracket 3588. In contrast, in the embodiment of FIG. 32A, the extension arm 3506 connects between the motor plate 3504 and the vibration head 3512. In embodiments, the vibration head is affixed to the motor plate via an extension arm. The different arrangement of the extension arms between the two embodiments can be used to create a different sensation of pressure of a vibrating surface such as indicated at 108 of FIG. 1. In this way, different embodiments can be selected for use based on preference for pressure from the vibration mechanism of disclosed embodiments.

The embodiments of FIGS. 17-39 may include the elements of FIG. 12. There includes the processor 1102 and a memory 1104 coupled to the processor 1102. The memory contains instructions, that when executed by the processor, cause the device to configure the thrust driver for a predetermined speed. In embodiments, the memory further contains instructions, that when executed by the processor, cause the device to configure the thrust driver to operate in a predetermined range of motion.

While the invention has been particularly shown and described in conjunction with exemplary embodiments, it will be appreciated that variations and modifications will occur to those skilled in the art. The embodiments according to the present invention may be implemented in association with the formation and/or processing of structures illustrated and described herein as well as in association with other structures not illustrated. Moreover, in particular regard to the various functions performed by the above described components (assemblies, devices, circuits, etc.), the terms used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more features of the other embodiments as may be desired and advantageous for any given or particular application. Therefore, it is to be understood that the appended claims are intended to cover all such modifications and changes that fall within the true spirit of the invention.

What is claimed is:

1. A sexual stimulation device, comprising:
an enclosure,
wherein the enclosure comprises:
a shaft-side surface,
a first concave side surface, and
a second concave side surface;
a thrustable shaft extending from the shaft-side surface of the enclosure; and
a driver mechanically coupled to the thrustable shaft, wherein the driver comprises:
a first servo motor; and
a second servo motor, wherein the second servo motor is mechanically coupled to the first servo motor.

2. The device of claim 1, wherein the driver further includes:
a first pivot arm coupled to the first servo motor;
a second pivot arm coupled to the second servo motor; and
a pivot arm coupler, connected between the first pivot arm and the second pivot arm.

3. The device of claim 1, further comprising a convex surface disposed opposite the shaft-side surface.

4. The device of claim 1, wherein the shaft-side surface further includes an external massage surface disposed thereon.

5. The device of claim 4, further comprising a massage motor, wherein the massage motor is coupled to the external massage surface.

6. The device of claim 1, wherein the shaft includes a silicone exterior surface.

7. The device of claim 4, wherein the massage motor comprises a vibration motor.

8. The device of claim 1, further comprising a removable or rechargeable battery.

9. The device of claim 1, further comprising:
a processor;
a memory coupled to the processor, the memory containing instructions, that when executed by the processor, cause the the driver to operate at a predetermined speed.

10. The device of claim 9, wherein the memory further contains instructions, that when executed by the processor, cause the driver to operate in a predetermined range of motion.

11. The device of claim 10, wherein the memory further contains instructions, that when executed by the processor, cause the first servo motor and second servo motor to operate in a synchronized manner.

12. A sexual stimulation device, comprising:
an enclosure,
wherein the enclosure comprises:
a shaft-side surface,
a first concave side surface, and
a second concave side surface;
a thrustable shaft extending from the shaft-side surface of the enclosure; and
a driver mechanically coupled to the thrustable shaft, wherein the thrust driver comprises:
a first servo motor;
a second servo motor, wherein the second servo motor is mechanically coupled to the first servo motor; and
an internal mount bracket affixed to an interior surface of the enclosure, wherein the first servo motor and second servo motor are affixed to the internal mount bracket.

13. The device of claim 12, wherein the internal mount bracket further comprises a shaft trackon which the thrustable shaft is movably disposed.

14. The device of claim 13 wherein the first servo motor and second servo motor are mounted in a motor plate.

15. The device of claim 14, further comprising a vibration head affixed to the motor plate via an extension arm.

16. The device of claim 15, further comprising a vibration motor coupled to the extension arm.

17. The device of claim 11 wherein the internal mount bracket is comprised of a single piece of plastic.

18. The device of claim 12, further comprising:
a processor;
a memory coupled to the processor, the memory containing instructions, that when executed by the processor, cause the driver to operate at a predetermined speed.

19. The device of claim 18, wherein the memory further contains instructions, that when executed by the processor, cause the driver to operate in a predetermined range of motion.

20. The device of claim 19, wherein the memory further contains instructions, that when executed by the processor, cause the the first servo motor and second servo motor to operate in a synchronized manner.
